(19) United States
(12) Patent Application Publication
(10) Pub. No.: US 2008/0241032 A1
(43) Pub. Date: Oct. 2, 2008

(54) Catalyzing Lean NOx Filter and Method of Using Same

(75) Inventor: Bilal Zuberi, Cambridge, MA (US)

Correspondence Address: GEO2 TECHNOLOGIES, 12-R CABOT ROAD, WOBURN, MA, 01801, US

(73) Assignee: GEO2 TECHNOLOGIES, INC., Woburn, MA (US)

(21) Appl. No.: 11/837,365

(22) Filed: Aug. 10, 2007

Related U.S. Application Data
(63) Continuation-in-part of application No. 11/695,585, filed on Apr. 2, 2007.
Application No. 11/695,585 is a continuation-in-part of application No. 11/736,388, filed on Apr. 17, 2007.

(51) Int. Cl. B01D 53/56; F01N 3/10

(52) U.S. Cl. 423/235; 423/212; 423/239.1; 423/239.2; 60/274; 60/299

(57) ABSTRACT

A NOx trapping filter is provided for use in emission control systems, for example, on the exhaust gas from an internal combustion engine. The NOx trapping filter has a substrate constructed using bonded fiber structures, which cooperate to form a highly uniform open cell network, as well as to provide a uniform arrangement of pores. The substrate typically is provided as a wall-flow honeycomb structure, and in one example, is manufactured using an extrusion process. In this way, the substrate has many channel walls, each having an inlet surface and an outlet surface. The inlet surface has a uniform arrangement of pores that form a soot capture zone, where soot and other particulate matter is captured from an exhaust gas. A NOx adsorber material is disposed in the filter to trap NOx during lean operation of the engine. A NOx conversion catalyst is also disposed inside the channel wall, where NOx and excess hydrocarbons in the exhaust gas are reacted to less harmful substances when the engine system is operated in a rich condition. Because of the uniform pore structure and open cell arrangement inside the channel wall, the filter is capable of being heavily loaded with catalyst, adsorber, while avoiding undue increase in backpressure to the internal combustion engine.

This application is a continuation-in-part of and claims priority to U.S. patent application Ser. No. 11/695,585, filed Apr. 2, 2007, and entitled “An Emission Control System Using a Multi-Function Catalyzing Filter”, and to U.S. patent application Ser. No. 11/763,388, filed Apr. 17, 2007 and entitled “A Selective Catalytic Reduction Filter and Method of Using Same”; and is related to U.S. patent application Ser. No. 11/323,429, filed Dec. 30, 2005, and entitled “An Extruded Porous Substrate and Products using the Same”; all of which are incorporated herein in their entirety.

### BACKGROUND

The field of the present invention is the construction and use of filters and catalyzing filters for pollution control in an emission control system. More particularly, the present invention relates to a multifunction filter for use with an internal combustion engine.

Internal combustion engines are essential to modern life. These engines power our cars, trucks, delivery vehicles, emergency generators, manufacturing equipment, farming equipment, and innumerable other machines and processes. Internal combustion engines typically are powered using a hydrocarbon fuel. Most often, this fuel is derived from crude oil, and is in the form of gasoline, diesel, or other liquid fuel. The internal combustion engine has evolved over time to provide excellent performance characteristics, extended durability, and low cost of operation. Due to these characteristics, the internal combustion engine continues to be a main power source for manufacturing, commercial, industrial, transportation, and residential use.

In operation, an internal combustion engine typically combines a hydrocarbon fuel with air, and ignites the mixture to generate an explosive power that is converted into a kinetic mechanical energy. Unfortunately, the burning of hydrocarbon fuels, and in particular fossil fuels, generates highly undesirable pollutants that harm the environment. For example, internal combustion engines generate volatile organic compounds, pollutant gases such as carbon monoxide and various derivatives of NOx, as well as soot and ash. Different types of internal combustion engines have different environmental impacts. For example, diesel engines typically generate far more soot than the gasoline powered engine, while having less environmental impact with NOx. Great strides have been made, primarily due to government regulation, to clean the exhaust from internal combustion engine systems. Larger internal combustion engines now typically have sophisticated engine control systems that monitor and adjust fuel-to-air ratios, as well as monitor other emission control characteristics. These engine control systems may adjust the engine to operate at a new performance or adjust a factor or add extra devices to the emission control system (i.e. after-treatment) to improve emission quality. Although the emission control systems are typically initially provide with a vehicle, additional emission control devices may be added to existing in-service vehicles by adding after-treatment or retrofit devices. Hybrid vehicles generally fall in the same category when they are not operating on the battery powered mode, and therefore may require additional emission controls when operating primarily on their internal combustion engine.

In a typical modern gasoline-powered passenger vehicle, several separate devices are provided for improved emissions control. In most cases, such systems are required to meet or exceed the regulatory emission limits. The vehicle may have two, three, or even more separate catalytic converters for converting various pollutants into less dangerous materials. In many countries, a gas powered passenger vehicle currently (2007) does not typically provide separate filtration for particulate matter or soot, even though some recent studies have highlighted the formation of nano-particle soot and secondary organic aerosol emissions from such engines (e.g. gasoline direct injection engines). The vehicle also has a complex engine control system for monitoring air/fuel ratios, and making real-time adaptations to the engine and emission control system for improved emission control. For a typical diesel-powered truck, a large particulate filter is now used for trapping soot and ash, and a sophisticated burn off control system is used for periodically regenerating the filter. Such filtering requirements may apply to heavy duty, medium duty, or even light duty, depending on the particular regulatory jurisdiction. In the regeneration process, the filter is heated sufficiently to burn soot, sometimes in the presence of a catalyst, into relatively harmless exhaustible by-products. For engine systems requiring a greater degree of emission control, after-treatment devices may have to be installed, as in-engine modifications and controls are not enough to meet the regulatory emission limits. After filtration, an additional separate catalytic conversion devices or canisters are provided for oxidation of unburnt hydrocarbons, carbon monoxide and for NOx reduction. In some cases, depending on the exact configuration of the emission control system, the NOx control device may be placed upstream or downstream of the filter. Additionally, sometimes cleanup catalyst systems are also needed to reduce leakage of criteria or toxic pollutants or reactants.

In some places, such as Europe, more stringent emission control standards require vehicles ranging from automotive cars to larger diesel delivery trucks to further reduce NOx emissions using systems such as NOx adsorbers, lean NOx traps, lean NOx catalysts, or SCR (selective catalytic reduction). For purposes of this discussion, the terms NOx adsorber, lean NOx trap (LNT), and NOx trap are used to refer to the same type of device, and may be used interchangeably. The SCR is either operated by the injection of hydrocarbon in the exhaust stream to reduce the NOx, or by injecting urea which decomposes to form NH₃. These trucks carry an additional refillable supply of urea (either in solution or solid state), which is introduced into the exhaust gas to generate ammonia. In some cases, technologies involving reformer systems and catalysts have been developed to generate on-board urea. The ammonia is reacted in a catalytic conversion device for converting NOx to relatively harmless byproducts, such as N₂.

Even today, a large volume of space is required for emission control devices and systems in both gasoline and diesel vehicles. In particular, most vehicles now require several separate units for the different aspects of after-treatment, for example for filtering and catalytic conversion, each consuming valuable volume in the vehicle, and limiting design options and making the design and manufacturing processes more complex. Further, adding these emission control systems, filters, and catalyzing devices add substantial expense to the cost of a new vehicle, as well as increase maintenance costs.

Governments are continually strengthening emission control standards, and requiring manufacturers to reduce carbon monoxide, NOx, and particulate emission. With the addition of each new regulation, manufacturers are further pressured to add more emission devices, enlarge current emission devices, and provide for more sophisticated emission control systems. Accordingly, over time the volume, cost, and design limitations presented by implementing emission standards becomes a substantial burden on any vehicle manufacturer. The same is true in the case of-road equipment and stationary engines where the space available for the mounting of emission control products is even more limited. Further, these additional emission control devices may negatively affect fuel efficiency. Although these engines will be cleaner, they put additional strain on the world's resources, and contribute to further emission of carbon dioxide, which has been linked to global climate change.

Recently, much attention has been directed to NOₓ reduction in exhausts from gasoline and diesel engines. NOₓ is the generic name for a group of highly reactive gases that contain varying amounts of NO and NO₂. NOₓ, although colorless and odorless, has highly detrimental environmental effects. About half the NOₓ emissions in the world are emitted from motor vehicles, including gasoline and diesel engines. Other significant sources of NOₓ, are typically more stationary facilities, such as electric utilities, industrial, and commercial sources, where NOₓ reduction devices are more readily incorporated. Motor vehicles provide a particularly difficult challenge due to the vast number of individual engines, the differences between engines, the changing environmental conditions at each engine, seasonal and geographic differences in fuels, and other unpredictable and dynamic environmental characteristics. Further, this dynamic combustion environment results in a particularly complex set of chemical reactions occurring in the engine, as well as in the multiple and complex after treatment systems deployed on mobile sources of NOx. Accordingly, reducing the level of NOₓ from motor vehicles has lagged behind managing the other sources, such as particulate matter (soot) and CO, but is now of primary importance.

NOₓ is generated in an engine when a hydrocarbon fuel explodes in a confined space of a piston cavity. Under this high temperature and high pressure condition, O₂ and N₂ combine to form NO. As exhaust gases leave the internal combustion engine, the temperature decreases, and a small amount of NO combines with O₂ to form NO₂ (nitrogen dioxide) in a reversible reaction. All engines emit NOₓ in varying degrees.

NOₓ has various detrimental environmental impacts, both to the environment generally and to human health in particular. As for direct environmental impact, NOₓ and volatile organic compounds react with heat and sunlight to form ground-level ozone or smog. Ground-level ozone and smog cause lung damage, and has adverse effects on those most susceptible to decreases in lung function, such as, asthmatics, and people who work or exercise outside. Smog and ground-level ozone also has a negative impact on vegetation and reduces crop yields. NOₓ also reacts with sulfur dioxide in the atmosphere to form acid rain, which falls to Earth with rain, fog, snow, or as dry particles. Acid rain damages or deteriorates cars, buildings, and monuments, as well as causes lakes and streams to become unsuitable for fish, and has other detrimental effects on wildlife. NOₓ also has a more direct affect on humans, by directly deteriorating the respiratory system. NOₓ reacts with ammonia, moisture, and other compounds in the air to form nitric acid and related particles. These particles damage lung tissue, and the small size of the particles penetrate deeply into sensitive parts of the lungs and cause or worsen potentially fatal respiratory diseases such as emphysema and bronchitis. With all these known dangers to NOₓ emissions, governmental agencies around the world are taking strong action to reduce the levels of NOₓ emitted into the atmosphere by internal combustion engines.

Since 1970, the US Environmental Protection Agency (EPA) has required motor vehicle manufacturers to reduce NOₓ emissions. Significant reductions have been achieved through auto emission controls. As a result, while miles traveled have increased in the US, NOₓ emissions from highway vehicles have decreased by almost 10%. Additional regulations have gone into effect in 2004 and 2007 to further limit NOₓ emissions. Other regulations will be phased in over time, which add even far more stringent regulation of vehicle emissions, including regulations for both diesel and gasoline internal combustion engines. For example, the EPA has defined a stringent standard for model year 2007 and later heavy duty vehicles (>8500 pounds), for both gas and diesel engines. The 2007 has a phase-in period for NOx reduction, but must be fully implemented by 2010. By 2010, diesel engines will be required to produce less than 0.01 g/bhp-hr particulate matter, while emitting less than 0.20 g/bhp-hr of NOₓ. Similarly strict regulations will apply to gasoline engines, but the gas engines have a different phase-in plan.

The European Community is also active in setting aggressive emission control standards. For example, the EuroV emission standard applies to vehicles sold from 2009 and later in the EU. EuroV set the following NOx limits according to vehicle weight and engine type:

| | | |
|---|---|---|
| Passenger car M1, gas | <0.06 | g/km |
| Passenger car M1, diesel | <0.18 | g/km |
| Light duty commercial (<1305 kg), gas | <0.06 | g/km |
| Light duty commercial (<1305 kg), diesel | <0.18 | g/km |
| Light duty commercial (<1760 kg), gas | <0.075 | g/km |
| Light duty commercial (<1760 kg), diesel | <0.235 | g/km |
| Light duty commercial (<3500 kg), gas | <0.082 | g/km |
| Light duty commercial (<3500 kg), diesel | <0.28 | g/km |
| Large Goods | <2.00 | g/kW |

Other stringent regulations for both gasoline and diesel engines are planned or likely in the US, Europe, Asia, and around the world.

Managing and reducing NOₓ emissions represent a significant problem to engine manufacturers and vehicle providers. For example, engine control systems are available that can adjust engine operating conditions to reduce the amount of NOₓ generated within the internal combustion engine. However, if the engine is adjusted so that NOₓ is decreased, the engine is running less efficiently and, therefore has decreased fuel economy and also emits more soot. Accordingly, it is unlikely that engine management alone will significantly impact the NOₓ reductions, especially to levels needed by 2010 in the US and to meet EuroV by 2009. NOₓ traps have also been proposed that are composed of materials (often barium salts) that store NOₓ under lean conditions, and then periodically release and catalytically reduce the stored NOₓ to CO₂ and N₂ during rich conditions. Although NOₓ traps may hold future promise, current direction favors selective catalytic reduction (SCR). SCR is a preferred solution for NOₓ management. In conjunction with engine management controls, SCR systems meter a precise amount of a chemical agent into the engines exhaust system. Often, this reagent is urea, or alternatively may be a source of hydrocarbons such as a fuel. If the reagent is urea, it is thoroughly mixed with the hot exhaust gas, and decomposes into ammonia. The resulting gas is subsequently reacted with a catalyst to generate nitrogen and water vapor. If the reagent is a fuel (hydrocarbon source), it is mixed with the hot exhaust gas, and the hydrocarbons react with NOx to generate nitrogen, carbon dioxide and water vapor. Using an SCR system managed by an engine control system, reductions in NOx levels of up to 90% or more are possible.

Such a known SCR system is illustrated in FIGS. 18 and 19. As illustrated in these figures, an engine generates an untreated exhaust gas which is mixed with a gas phase additive prior to being received into an SCR catalyst device. In an SCR system, the gas phase additive may be urea (NH₂)₂CO, which reacts with the hot exhaust gas to form ammonia NH₃, and carbon dioxide. The gases are received into an SCR catalyst, where the ammonia reacts with NOx in the presence of a catalyst material to be reduced into relatively harmless nitrogen gas. Alternatively, the gas phase additive may be a hydrocarbon (HC) source, such a fuel, which is released from time-to-time to cause an HC-rich environment. In the HC-rich environment, trapped NOx (typically NO₂) is released and reacts with HC in the presence of a catalyst material to be reduced into relatively harmless nitrogen gas, carbon dioxide, and water. Selection and application of the catalyst is particularly important in systems for mobile internal combustion engines. As opposed to stationary applications, internal combustion engines operate under a much wider temperature window, more variation in mass flow, and have transient duty cycles. Currently, platinum, vanadium oxide or (vanadia), and zeolites are proving effective, although developing health concerns regarding vanadium may limit choices.

Another important consideration is the placement of the SCR catalytic device in relation to other emission control devices. For example, operating the SCR catalyst at low temperatures may present problems both in conversion efficiency and in catalyst durability or survivability. In this regard, the catalyst typically does not reach full efficiency until a relatively high operating temperature has been reached. Further, the SCR catalyst material may be consumed or deactivated during some low-temperature reactions, so continual or prolonged operation in low temperatures may substantially and permanently degrade the performance of the SCR catalyst. Accordingly, it is desirable that the SCR device reaches its operating temperature quickly, which suggests that the SCR catalyst be positioned closer to the outlet of the internal combustion engine. Such a system is illustrated in FIG. 18, where the SCR catalyst is positioned close to the internal combustion engine. In this way, NOₓ reduction is performed in the SCR catalyst, and then the reacted exhaust gas is sent to a particulate filter where soot is removed.

However, the exhaust emitted from the internal combustion engine typically contains levels of soot, which may act to clog the SCR catalyst, react or deactivate the catalyst material, or otherwise interfere with effective NOₓ control. As illustrated in FIG. 19, it therefore may be desired to place a particulate filter closer to the internal combustion engine, and therefore the SCR catalyst is able to react a soot-reduced gas. Unfortunately, the arrangement shown in FIG. 19 has a longer light-off period before the SCR catalyst reaches its preferred operational temperatures. In this way, ammonia may slip through the system, catalyst material may be permanently deactivated, and the level of overall NOₓ reduction is undesirable. Lately the formation of additional NO₂ from NO conversion in the upstream DOC and DPF have also been questioned, which affects the chemical reaction balance inside the SCR catalyst system. FIGS. 18 and 19 also show the SCR system having an engine control system. The engine control system typically is a closed loop control system having feedback from measurements taken at various points along the exhaust path. However, for less stringent NOₓ control, an open loop control system may be sufficient.

Selecting the proper SCR catalyst and positioning the SCR device is also complicated in that each SCR catalyst has a different preferred operating temperatures. For example, platinum is most effective in a narrow band of temperatures below about 250° C., with performance quickly deteriorating above that range. Accordingly, a platinum-based SCR catalyst must be positioned to maintain operating temperature in a relatively narrow band. Further, this narrow window for temperature control adds expense and complexity to the overall process design, especially to the engine control system. Vanadia has a higher and wider operational band than platinum, effectively reducing NOₓ from about 300° C. to about 400° C. Even higher temperatures are effective for zeolite (especially Cu, Fe or otherwise substituted zeolites), which is efficient at temperatures over 400° C. Although vanadia and zeolite have wider operating bands, and are therefore more easily integrated into a mobile emission control system, their higher initial temperature requirements may lead to undesirable ammonia slip and efficient or effective NOx control at lower temperatures, for example, at startup. Sophisticated engine control is still required even with vanadia or zeolite SCR systems, as both catalysts degrade at elevated temperatures.

Also, for a practical commercial implication, it is likely that the exhaust systems of FIGS. 18 and 19 would be augmented with other catalytic devices. For example, an oxidation catalyst device may be provided for conversion of hydrocarbon gases and carbon monoxide into carbon dioxide and water, and in some cases, more than one oxidation catalyst will be provided. A typical passenger vehicle may have an oxidation catalyst near the internal combustion engine for providing oxidation immediately after startup and a main oxidation catalysts that performs higher levels of oxidation after an operational temperature is reached. In a specific example, another oxidation catalyst may be provided after the SCR device to oxidize ammonia slip, which is present due to imperfect conversion within the SCR catalyst.

In an SCR system, even under optimal conditions, some of the catalyst may be consumed or permanently deactivated. Accordingly, in order for an SCR to effectively manage NOₓ reductions over the expected life of the vehicle, a substantial and heavy loading of the catalyst is typically required. SCR reactions also work well in the case of high residence times for the gas in the reactor and for low gas space velocities. Because of this heavy loading, the SCR catalyst device may restrict the flow of exhaust gases, thereby increasing the backpressure to the engine. Such an increase in backpressure is detrimental to fuel economy, and therefore the SCR catalyst device is sized to reduce the negative impact on that pressure. Of course, these larger SCR devices consume more valuable space in a vehicle, making manufacturing and design more difficult, and also add additional cost.

Therefore, there exists a need to provide emission control devices that can efficiently meet current and evolving emission standards for NOx, while minimizing the overall size, cost, and complexity of the emission control system.

### SUMMARY

Briefly, the present invention provides a Selective Catalytic Reduction (SCR) filter for use in emission control systems, for example, on the exhaust gas from an internal combustion engine. This device can alternatively be called a NOx trap, an NOx adsorber, a Lean NOx Trap (LNT) filter or an LNT-SCR filter, depending on the exact composition and configuration of the catalysts deposited on the filter, and the chemical reactions that are utilized to reduce emissions. The SCR filter has a substrate constructed using bonded fiber structures, which cooperate to form a highly uniform open cell network within the wall pore architecture, as well as to provide a uniform arrangement of pores. The substrate typically is provided as a wall-flow honeycomb structure, and in one example, is manufactured using an extrusion process. In this way, the substrate has many channel walls, each having an inlet surface and an outlet surface. The inlet surface has a uniform arrangement of pores that form a soot capture zone, where soot and other particulate matter is captured from an exhaust gas. A NOx adsorber material is disposed in the filter to trap NOx during lean operation of the engine. A NOx conversion catalyst is also disposed inside the channel wall, where NOx and excess hydrocarbons in the exhaust gas are reacted to less harmful substances when the engine system is operated in a rich condition. Because of the uniform pore structure and open cell arrangement inside the channel wall, the filter is capable of being heavily loaded with catalyst, adsorber, while avoiding undue increase in backpressure to the internal combustion engine.

In one example, the SCR filter has a single soot collection zone and a single NOx conversion zone. The NOx conversion zone may be inside the channel wall, adjacent to the inlet surfaces, or adjacent to the outlet surfaces. Accordingly, the position of the NOx conversion zone, as well as the particular catalyst or combination of catalysts, may be selected to support a wide range of emission control requirements. In the NOx conversion zone, a NOx trapping material may be loaded for trapping NOx during lean operation in a chemically bonded form, and for releasing NO, NO₂, or NH3 during rich operation. The trapping material and a catalyst may be evenly loaded, or they may be loaded according to a gradient. The NOx conversion zone may also have multiple catalysts layered onto the fiber structures according to known processes to assist in other catalytic reactions, such as the reduction of NO or NO2 to N2 or oxidation of NH3 to N2.

In another example, the SCR filter has one or more other gas conversion zones. These other zones may be used for oxidation processes, soot regeneration, or as a slip catalyst. These zones may be layered within a channel wall, or may be positioned in separate locations in the filter. In one construction, a first catalyst is applied toward the inlet end of the substrate, and another catalyst is applied toward the outlet end of the substrate. In this way, the channel areas nearer the inlet act as a first gas conversion zone, while the channel areas nearer the outlet act as a second gas conversion zone. In yet another example, the soot collection zone and a gas conversion zone share the same channel area. In this regard, a soot-regeneration catalyst may be disposed in the soot collection area to assist in lower temperature soot burn-off. In another case, a gas conversion catalyst may be disposed in the soot collection area to assist in generating transient molecules that are consumed in other downstream processes. In another illustration, a gas conversion catalyst may be disposed in the soot collection area to assist in converting a pollutant gas to a less harmful substance, thereby increasing the overall conversion efficiently of the filter.

In operation, the SCR filter may be provided in a single device, which is typically in the form of a can. In this way, a single can is able to both effectively trap soot, as well as enable highly efficient trapping and subsequent catalytic conversion of NOx. Since the SCR filter may be heavily loaded with catalyst and trapping material, the SCR filter exhibits greatly improved conversion efficiencies, even for relatively slow reactions; has an extended useful life, even in processes where catalyst is consumed or deactivated; and provides sufficient catalyst surface area to meet stringent new emission standards for NOx. Since all this is done in a single can, the engine control system is simplified, less expensive, and easier to design into new vehicles. Importantly, even as a single can solution, the SCR filter does not cause undue backpressure to the engine, and avoids undesirable channeling effects when loading and unloading soot.

### BRIEF DESCRIPTION OF THE DRAWINGS

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views. It will also be understood that certain components and details may not appear in the figures to assist in more clearly describing the invention.

FIG. 1 is a simplified block diagram of a emission control system in accordance with the present invention;

FIG. 2 is a flow chart of an emission control system in accordance with the present invention;

FIG. 3 is a substrate for a multi-function filter in accordance with the present invention;

FIG. 4 is an enlarged sectional view of a channel wall structure for the substrate illustrated in FIG. 3;

FIG. 5 is an enlarged sectional view of a channel wall structure for the substrate illustrated in FIG. 3;

FIG. 6 is an enlarged sectional view of a portion of a single channel wall for the substrate illustrated in FIG. 3;

FIG. 7 is an illustration of a bonded fiber arrangement providing highly uniform pore structures;

FIG. 8 is a scanning electron microscope photograph showing a bonded fiber arrangement providing highly uniform pore structures;

FIG. 9 is an illustration of a bonded fiber arrangement providing highly uniform pore structures;

FIG. 10 is a block diagram showing a process for filtering and catalyzing an exhaust gas using a multifunction filter in accordance with the present invention;

FIG. 11 is a functional block diagram of a wall flow multifunction filter in accordance with the present invention;

FIG. 12 is a flowchart of a process of forming a multifunction filter in accordance with the present invention;

FIG. 13 is a block diagram of a wall flow multifunction filter having multiple gas phase reaction zones; and

FIG. 14 is a flowchart of a process of making a substrate for a multifunction filter in accordance with the present invention;

FIG. 15 is a block diagram of an SCR multifunction filter in accordance with the present invention;

FIG. 16 is a flowchart of the process of using an SCR multifunction filter in accordance with the present invention;

FIG. 17 is a flowchart of making a multifunction filter in accordance with the present invention;

FIG. 18 is a block diagram of a known emission control system having a separate SCR catalyst and a separate particulate filter; and

FIG. 19 is a block diagram of a known emission control system having a separate SCR catalyst and a separate particulate filter.

### DETAILED DESCRIPTION

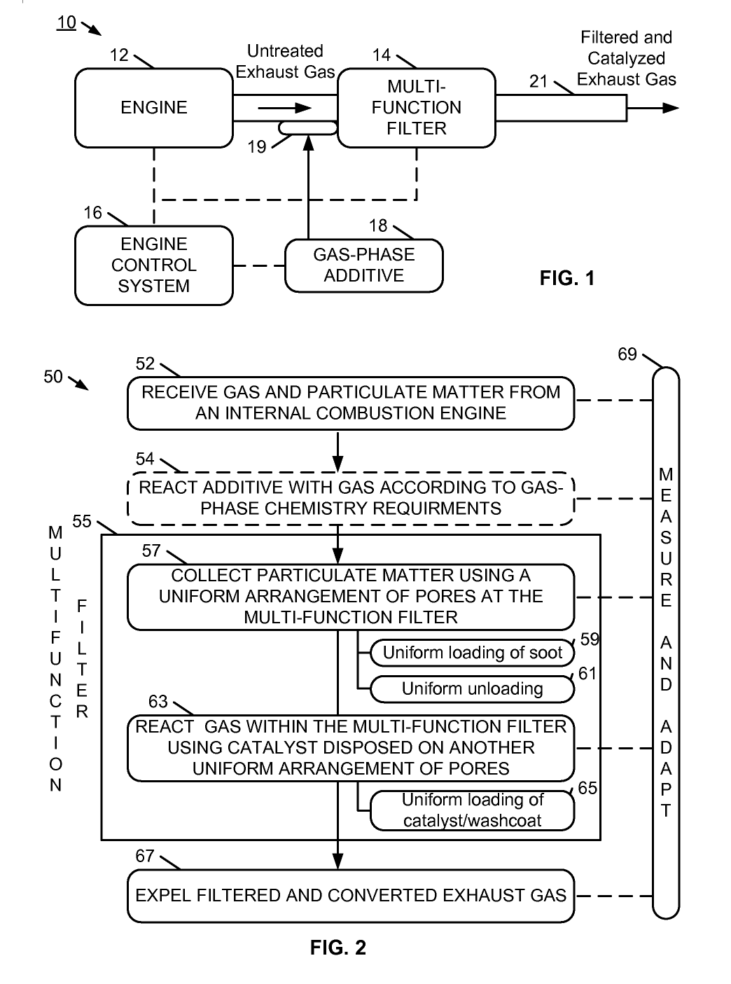

Referring now to FIG. 1, emission control system 10 is illustrated. Emission control system 10 is constructed for use with an internal combustion engine to provide pollution control. As such, emission control system 10 advantageously may be used with gasoline, diesel, or other hydrocarbon-based internal combustion engine systems. Alternatively, such a system could also be used in emission control devices that are not mounted on an internal combustion engine, such as smokestacks, chimneys, and other such commercial or industrial applications. Since the design and construction of engines, engine control systems, and general exhaust system components are well known, these will not be described in detail. Emission system 10 has internal combustion engine 12 operating, for example, on diesel or gasoline fuel. Engine 12 emits an untreated exhaust gas containing various pollutants, such as particulate matter, volatile organic compounds (VOC), and pollutant gases. The untreated exhaust gas 19 is received into multi-function filter 14. The multi-function filter 14 is a single discrete device for both filtering particulate matter from the untreated gas, and for facilitating catalytic conversion of one or more pollutant gases. Advantageously, exhaust 21 from multi-function filter 14 is a filtered and catalyzed exhaust gas that complies with new and evolving emission control standards. Importantly, the filtering and catalyzing process has been enabled within a single multifunction filter assembly, reducing the size, complexity or cost of the other emission control devices in the exhaust systems. Accordingly, the multifunction filter 14 consumes less space in a vehicle, may be more conveniently integrated into vehicle aesthetics, and simplifies construction, maintenance, and repair.

In some cases, a gas-phase additive 18 will be mixed with the untreated exhaust gas in mixing chamber 19. This gas-phase additive reacts with one or more gases in the untreated exhaust gas 19 to create an intermediate substance that may be more readily catalyzed or otherwise removed within the multifunction filter 14. Although emission control system 10 is illustrated with a single multifunction filter 14, it will be appreciated that other catalysts and filters may be provided in the overall exhaust path. Emission control system 10 also has engine control system 16 for managing the individual components of emission control system 10. For example, engine control system 16 may communicate with engine 12 to determine performance characteristics, may monitor the multifunction filter 14, and may make adjustments to improve overall pollution control or engine performance. In one example, engine control system 16 may monitor for an undue increase in back pressure in the multifunction filter 14, and in response, initiate a burn-off process to unload accumulated soot. It will be appreciated that engine control system 16 may monitor several aspects of emission control system, and may make adjustments according to the specific engine and exhaust design. Since the design and implementation of engine control systems is well known, engine control system 16 will not be described in detail.

Multifunction filter 14 has been constructed in a way that provides for both 1) highly efficient soot capture and regeneration, as well as 2) enabling highly efficient gas catalyzing processes, while maintaining desirable back pressure, soot loading, soot unloading, and burn off characteristics. In this way, emission control system 10 provides the first known multi-function filter capable of meeting stringent particulate and pollution control standards evolving in Europe, the United States, and in other countries around the world. Advantageously, use of the multifunction filter 14 provides exceptional particulate and pollution control, while allowing internal combustion engines to meet performance requirements. For example, since multifunction filter 14 has exceptional back pressure characteristics, an associated internal combustion engine is able to more efficiently operate, and thereby maintaining or improving its fuel economy. In this way, the multi-function filter 14 may enable vehicles to emit cleaner exhaust, without the typical degradation to fuel economy. Use of the disclosed multifunction filter 14 thereby protects the earth's atmosphere by providing for effective pollution control, and at the same time helps to reduce dependency on carbon-based fuels by enabling better fuel efficiencies.

Multifunction filter 14 may be better understood with reference to FIG. 2, where a process 50 is described for operation on multifunction filter 14. Multifunction filter 14 receives gas and particulate matter from an internal combustion engine as shown in block 52. In some cases, an additive may be reacted with the gas according to the particular gas-phase chemistry requirements as shown in block 54. Typically, additive mixing is achieved in a mixing chamber prior to the gas being received into multifunction filter 55. In one example, the additive is urea, which is decomposed to form ammonia by the heat from the exhaust. It will be appreciated that other catalyst processes may be used to facilitate improved ammonia formation. The ammonia (decomposed urea) is received into multifunction filter 55, where it reacts with nitrogen oxides in a reduction reaction to produce harmless nitrogen gas. It will also be appreciated that other additives may be used for creating other intermediate products for the removal of other pollutant gases according to application needs. For example ceria or iron based nanoparticles may be used to catalyze the combustion of soot.

The exhaust gas is received into multifunction filter 55. The multifunction filter 55 performs two distinct functions within a single substrate: first, highly effective soot capture; and second, it hosts an efficient gas-phase process. In its filtering role, multifunction filter 55 collects particulate matter using a highly uniform arrangement of pores. This highly uniform arrangement of pores has a relatively narrow distribution of pore sizes, as well as a generally open, inter-connected pore structure. This means that soot may be captured in a regular and uniform manner, and in some cases acts as an especially efficient cake filtering structure. With such a highly organized and arranged pore structure and size distribution, a very uniform loading of soot is achieved as shown in block 59. In a similar manner, this same pore structure contributes to a highly uniform unloading of soot as shown in block 61. Uniform loading and unloading is advantageous, as it reduces undesirable channeling effects within the filter. In previous filters, channeling effects occur within a filter as pores fill with trapped soot. In these filters, since there is a wide distribution of pore sizes, and many pore paths are blocked, exhaust gases initially move along a path of least resistance, which typically will be through some set of relatively aligned and large pores. Operating in this state, the filter has a very low back pressure. However, as these initial pore networks clog with trapped soot, the exhaust gas is forced to take alternative paths. While these paths are being established, the filter's backpressure may undergo an undesirable and sizeable increase, and the overall performance of the emission control system declines. This spike in backpressure wreaks havoc on the overall emission control system, complicating design and implementation, and causes irregular emission control performance. For example, the control strategies used for regenerating such filters are often under-utilizing the filter to make sure no backpressure spikes are observed. In contrast, the more regular and uniform distribution provided in multifunction filter 55 avoids much of this channeling effect, thereby maintaining efficiency over the loading and unloading process. The open pore structure of multifunction filter 55 also allows gases to flow more uniformly and freely into internal areas of the multifunction filter. It also makes the porosity inside the wall fully accessible for catalyst loading and gas permeation. And finally, the washcoat and catalyst is better dispersed through the filter wall system to lead to reduced catalyst sintering, ostwald's ripening and degradation.

Within the multifunction filter 55, the filtered gas is reacted with one or more catalysts that have been disposed on the internal arrangement of pores. The arrangement of pores within the multifunction filter is also a generally uniform arrangement, and is constructed as a highly open cell network of pores. Typically, a washcoat is disposed on to the substrate surface, which facilitates better adhesion and distribution of the catalyst or catalysts. Advantageously, the uniform nature of the pore structure within the multifunction filter enables a uniform loading of the washcoat and catalyst as shown in block 65. Further, because of the open pore, interconnected pore network, the washcoat and catalyst may be disposed at very high loading levels. These high loading levels are highly advantageous for efficient catalyst processes, as well as desirable to assure long-term survivability. It will also be appreciated that multifunction filter 55 may have a single catalyst for reacting a single pollutant gas, or may have multiple catalysts arranged for reacting multiple pollutant gases. The gas expelled from the multifunction filter 55 has been filtered and reacted as shown in block 67. An engine control system 69 may monitor various aspects of process 50, and make adaptations for improved emission control or engine performance.

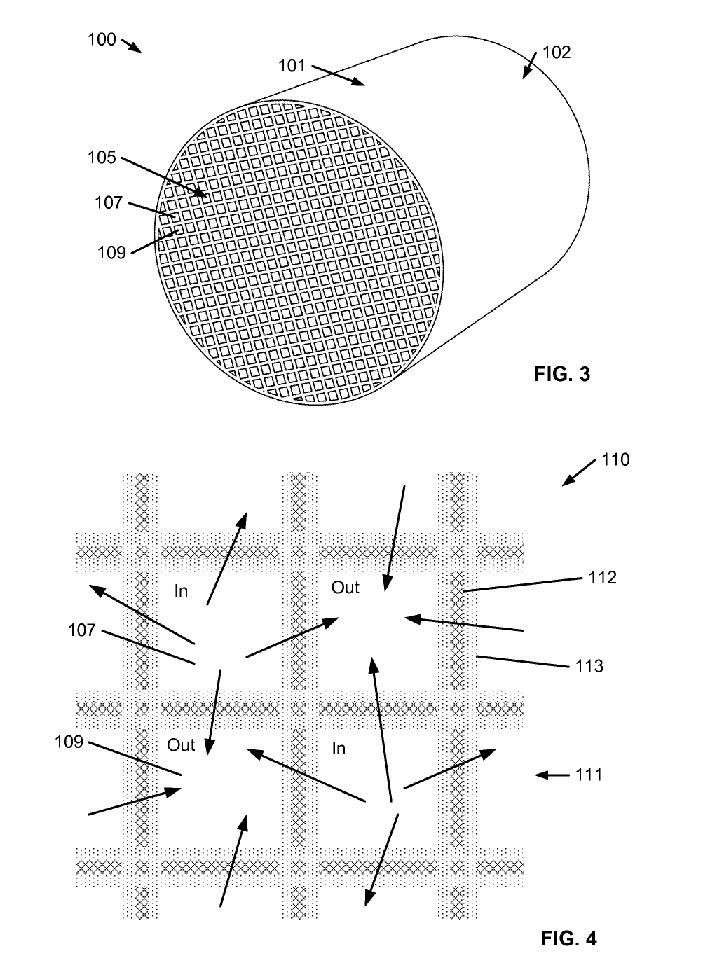

Referring now to FIG. 3, a substrate 100 is illustrated. In one example, substrate 100 may advantageously be used in a multifunction filter, such as multifunction filter 14 described with reference to FIG. 1. While substrate 100 may be manufactured in alternative ways, extrusion has been found to be a particularly efficient and effective process. Generally, the extrusion process mixes together fibers or fiber precursors with pore formers, plasticizers, and fluids to form an extrudable mixture at the proper rheology. The extrudable mixture is then forced through the die of an extruder, thereby generating a green substrate having a honeycomb form. The green substrate is first dried to remove fluids, and then further heated to remove pore formers, volatile organic and inorganic materials, and finally to form a bonded fibrous structure.

It is this bonded fibrous structure that enables the multifunction filter to efficiently act as both a filter and a catalyzing substrate. The bonded fibrous structure is identifiable in its finished form by the uniform arrangement of pores, and the relatively narrow distribution of pore sizes. Although there is a high degree of uniformity, different zones of substrate 100 may have different uniform arrangements. For example, the extrusion process may provide for one geometry of pore structure at or near the surface of each channel wall, while a somewhat different, yet uniform, pore structure may exist more towards the inside or middle of each channel wall. Indeed, these differences in zone pore structures may beneficially be used to adapt substrates for particular filtering and catalytic requirements. The pore-structure can be altered in a controlled fashion by changing the raw material inputs, and the processing processes and parameters during extrusion and sintering.

The bonded fibrous structure may be manufactured in different ways. For example the bonded fibrous structure may be constructed as an arrangement of individual fiber or fiber-like structures that are bonded together at overlapping nodes. In another example, fiber structures include individual fibers, fibers formed into multi-fiber bundles or multi-fiber clumps. These collections of fiber structures bond with other fibers, bundles, or clumps to form a bonded fibrous structure having a highly desirable open, inter-connected pore network. It will also be appreciated that the bonded fibrous structure may use fiber strands in the extrudable mixture, which are then bonded to other fibers during sintering, or the extrudable mixture may have precursors to the fiber or fiber-like structure, whereby the fibers or fiber-like structures form during the sintering process. It will also be understood that the fibers or fiber-like structures may be formed from different materials. For example, organics, carbon, oxides, carbides, nitrides, metals, steels, or metal alloys may be used as the fiber or fiber precursors. It will also be understood that the bond between fibers, fiber bundles, or the fiber-like structures may be ceramic, glass, liquid state sintered, solid state sintered, or another type of sintering bond. For the multifunction filter, it is the unique functional characteristics of the resulting bonded structure that is most meaningful, since there are many ways to commercially manufacture such a fibrous bonded, often extruded honeycomb, structure.

Further detailed discussion of extruding and sintering a bonded fibrous substrate may be found in U.S. patent application Ser. No. 11/323,429, filed Dec. 30, 2005, and entitled An Extruded Porous Substrate and Products using the Same, which is incorporated by reference herein in its entirety. As illustrated in FIG. 3, substrate 100 has many channels formed in a honeycomb pattern. This honeycomb may have a channel density of, for example, 100 to 900 cells per square inch. In some cases where high flow rates are required, even smaller cell densities, as low as 10 cells per square inch, may be used as well. It will be understood that other cell densities may be used for other particular applications. In a particular construction, substrate 100 has alternating channels blocked or plugged at each end. In this way, an inlet channel 107 receives a gas flow, and the gas flows through channel walls into one or more output channels 109. The gas then continues down the outlet channel until it is exhausted. Generally, this type of channel arrangement is referred to as a “wallflow” filter construction.

A washcoat and catalyst is applied to substrate 100 for converting one or more pollutant gases to a less harmful substance. The substrate may host a single type of catalyst, either in a relatively even loading from the inlet side 111 to the outlet side 112, or may be applied with a gradient loading. In this way, a heavier loading may be provided toward one end, while a lesser loading is applied at the other end. Also, the substrate is capable of hosting two or more different catalysts. In one example, a first catalyst is disposed toward the inlet side 101 of the filter, and the second catalyst may be disposed toward the outlet end 102. In this way, the first catalyst may be injected or received through the inlet side 101 openings, and the second catalyst may be injected or received through the outlet side 102 openings. In another example, multiple catalysts may be layered on the fiber structures, or, cell walls may have multiple zones, with each zone having its own catalytic purpose. In yet another example, the catalyst loading levels may be different in the different zones. As an illustration, the surface adjacent to an inlet wall may have a catalyst for assisting in lower temperature soot burn-off, the interior of the channel wall may have a catalyst to assist in NOx reduction, and an area adjacent to the outlet wall may have a cleanup or oxidation catalyst. In this way, a single substrate may efficiently provide or multiple catalytic processes.

FIG. 4 shows an enlarged cross-section of part of the honeycomb structure of substrate 100. Enlargement 110 shows inlet channel 107 adjacent to several output channels, including outlet channel 109. Each of the channel walls 111 is a bonded fibrous structure. Each inlet channel wall has a zone 113 having a particulate loading area having a highly uniform pore structure. For convenience, since soot is the most common particulate, this will be general referred to as a soot capture zone. However, it will be appreciated that other particulates may be used. Typically, the soot capture zone extends from the surface of the channel wall into the initial set of pores. The depth of the soot capture zone will generally be a function of the pore-size, which can be set by changing the size or shape of pore-formers and fibers etc. For example, a larger pore arrangement will result in a fiber structure that acts more like a depth filter, whereas an arrangements of smaller pores will function more as a cake filter. Within this soot capture zone the bonded fibrous structure has a pore structure arranged for an even loading or unloading of soot. This even loading reduces undesirable channeling effects for an operating multifunction filter. Each of the channel walls also has a gas-phased zone in an interior area. The gas-phased zone also has a highly uniform open pore structure, although the structure may vary from the pore structure in the soot capture zone. The open pore structure within the gas-phase zone enables an unusually heavy loading of washcoat and catalyst. In this way a highly efficient and survivable multifunction filter may be made. Often, the catalyst of choice is platinum, although other catalysts may be used. It will also be appreciated that more than one type of washcoat or more than one type of catalyst may be used. In this way, a single multifunction filter is able to filter and react to or more pollutant gases. The soot collection zone may also be coated in the same or a different catalyst. For example, the soot collection zone may also be coated with a washcoat and platinum, which assists in low temperature soot oxidation, although other catalysts may be selected that also help in the regeneration of soot.

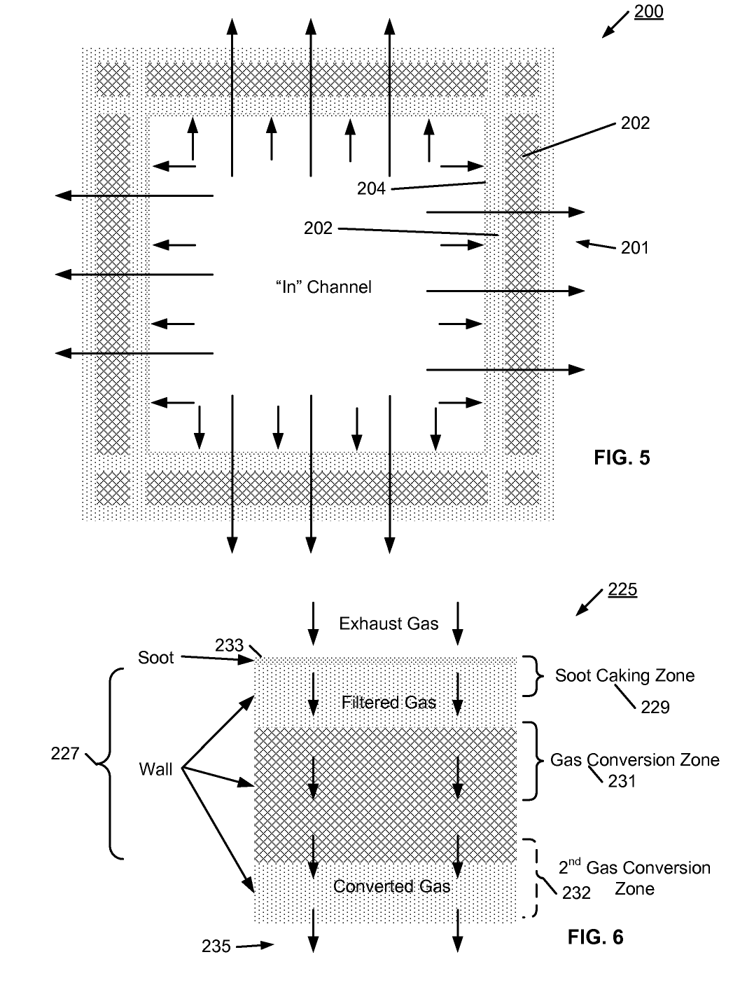

A further enlargement of the channel wall structure is illustrated in FIG. 5. Here, a single inlet channel 200 is illustrated. Channel 200 has channel walls 201 having a soot capture zone 204 and a gas phase zone 202. As illustrated, gas is received into the inlet channel, which then moves through channel walls 201 into an outlet channel. Particulate matter is captured on the soot capture zone 204, while the filtered gas moves into the gas-phase zone 202. In the gas-phase zone, a tortuous gas flow occurs within the uniform open cell network, allowing efficient contact of pollutant gas molecules with the catalyst active surfaces. Upon contact, the pollutant gases are converted to less harmful components. The filtered and reacted gas then moves from the channel walls into adjacent outlet channels, and is then expelled from the multifunction filter.

FIG. 6 shows yet a further enlargement of a channel wall 225 for a multifunction filter substrate. Filter wall 225 is constructed as a bonded fibrous substrate 227. The bonded fibrous substrate 227 has two distinct zones, which may or may not be contiguous. A first soot capture zone 229 has a highly uniform pore structure and arrangement, as well as a reasonably narrow pore-size distribution. A second gas-phase conversion zone 231 is found within the channel wall. The gas-phase zone also has a highly uniform pore structure, although the pore structure may be different from that of the soot capture zone 229. Exhaust gas is received at the inlet channel wall, typically from an internal combustion engine. The exhaust gas typically has both particulate matter and pollutant gases. The exhaust gas first passes through the soot capture zone 229, where the soot 233 is captured at or near the surface of the inlet channel wall. The filtered gas continues through to the gas-phase zone 231, where the gas pollutant molecules contact catalyst, and are converted to less harmful gases. For example, CO may be converted to CO₂ in an oxidation process, or NOx may be converted in a NOx reduction process. The filtered and reacted gas is then exhausted into outlet channel 235. Optionally, another gas conversions zone 232 may be layered in the channel wall. The second zone may be used to support conversions of a second pollutant gas. In this way, the first gas zone 231 may convert a first pollutant, such as NOx, and the second gas zone 232 may convert a second pollutant, such as CO or VOCs. Although the second gas zone 232 is illustrated downstream from the first gas zone, it will be appreciated that it may be located upstream, for example, adjacent to the soot collection zone 229.

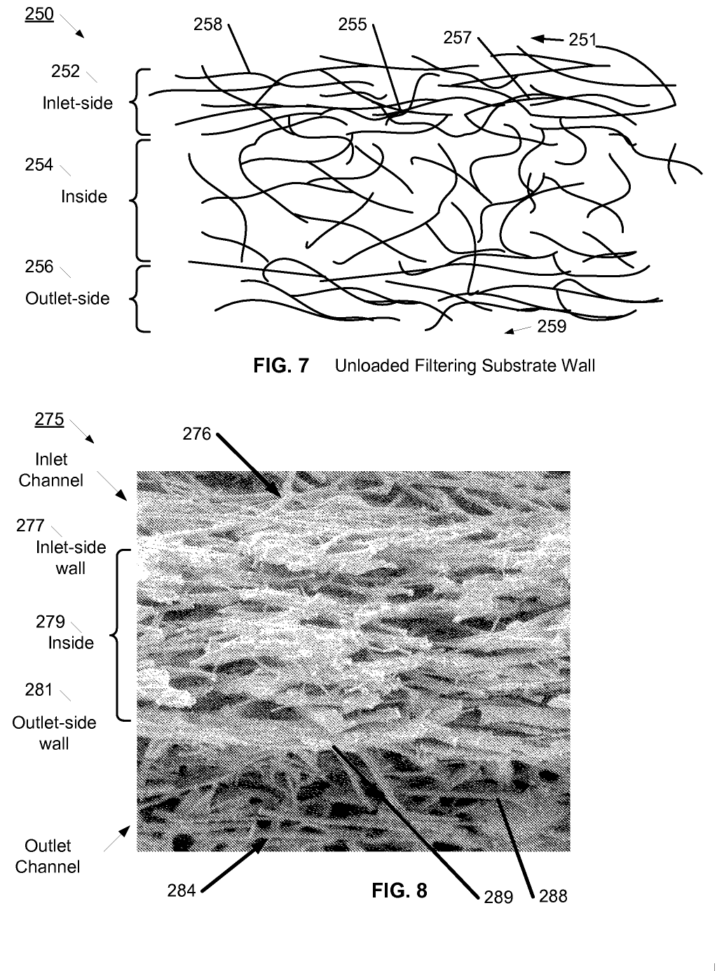

FIG. 7 shows a simplified diagram of a channel wall 250 similar to channel wall 225 described with reference to FIG. 6. Channel wall 250 has is positioned between an inlet channel 251 and an outlet channel 259. The channel wall 250 is a bonded fibrous substrate, having individual fibers 258, fiber bundles 257, and clumps of fibers 255 that are bonded together to form an open pore network. This open pore network further has a highly uniform pore arrangement, due to the consistent physical characteristics of the fibers or fiber like structures. Channel wall 250 has a soot capture zone 252 for capturing particulate matter and passing filtered gas into the gas-phase zone 254. The gas-phase zone also has a highly uniform pore structure, although the pore structure may be different than the pore structure in the soot capture zone 202. As exhaust gas passes through the gas-phase zone, pollutant molecules react with catalyst, forming less harmful gases. The surface adjacent the outlet channel has a pore structure similar to the soot capture zone, however is used primarily for structural support of the channel wall 250. In another example, a different catalyst may be disposed in the outlet side 256 as opposed to the catalyst in the gas-phase zone 254. In such a case, the outlet side 256 would act as a second gas-phase zone in the multifunction filter.

Referring now to FIG. 8, and scanning electron microscope (SEM) image of a channel wall 275 illustrated. Channel wall 275 is a cross-sectional view showing an inlet channel 276 and an outlet channel 284. The channel wall 275 is a bonded fibrous structure 276, having individual fibers 288, fiber bundles 284, and fiber clumps 289 bonded together in an open pore network. Although wall 275 uses fibers, it will be understood that other materials may be used to effect the functionality of fiber. For example, fiber-like structures may be introduced in an extrusion mix, with fiber-like structures formed during the sintering process. Accordingly, for the multifunction filter, it is the unique functional characteristics of the resulting bonded structure that is most meaningful, since there are many ways to commercially manufacture such a fibrous bonded structure. In operation, and exhaust gas is received from the inlet channel 276, which passes through the soot capture zone 277, where soot captures at or near the surface. The filtered gas continues through to the gas-phase zone 279, where gas molecules react with catalyst to form less harmful materials. The gas is then exhausted into outlet channel 284. The outside wall 281 provides additional structural integrity for the channel wall 275. As illustrated, the soot capture zone 277 has a highly uniform pore structure, but is different than the highly uniform pore structure in the gas-phase zone 279.

In manufacturing the multifunction filter for channel wall 275, mullite fibers were mixed with approximately 44 micron (325 mesh) particle size carbon as a pore former, colloidal silica, organic and inorganic binders and plasticizers, along with water. The mixture was aggressively and thoroughly mixed to an extrudable rheology. A piston/ram extruder was used to extrude a green substrate at 200 cells per square inch. The green substrate was dried in an RF oven, and then heated to about 1000 degrees Celsius for approximately 28 hours to burn out organic materials, and sintered at 1500 degrees Celsius for about one hour. After cooling, the multifunction filter can be coated with washcoat, having one or more catalysts applied, and be secured into a can, canister, or other container. In some constructions, the washcoat material or precursors may be included in the extrudable mixture, and the washcoat exposed or formed during the sintering process. In this way, the additional step of applying the washcoat may be avoided or simplified, and the washcoat is evenly distributed throughout the filter substrate. Although a specific recipe for manufacturing a multifunction filter is described, it will be appreciated that many other fibers, fiber precursors, pore formers, plasticizers, bonding agents or precursors or fluids may be used. It will also be appreciated that other types of machines and processes may be used for mixing, extruding, drying, and sintering.

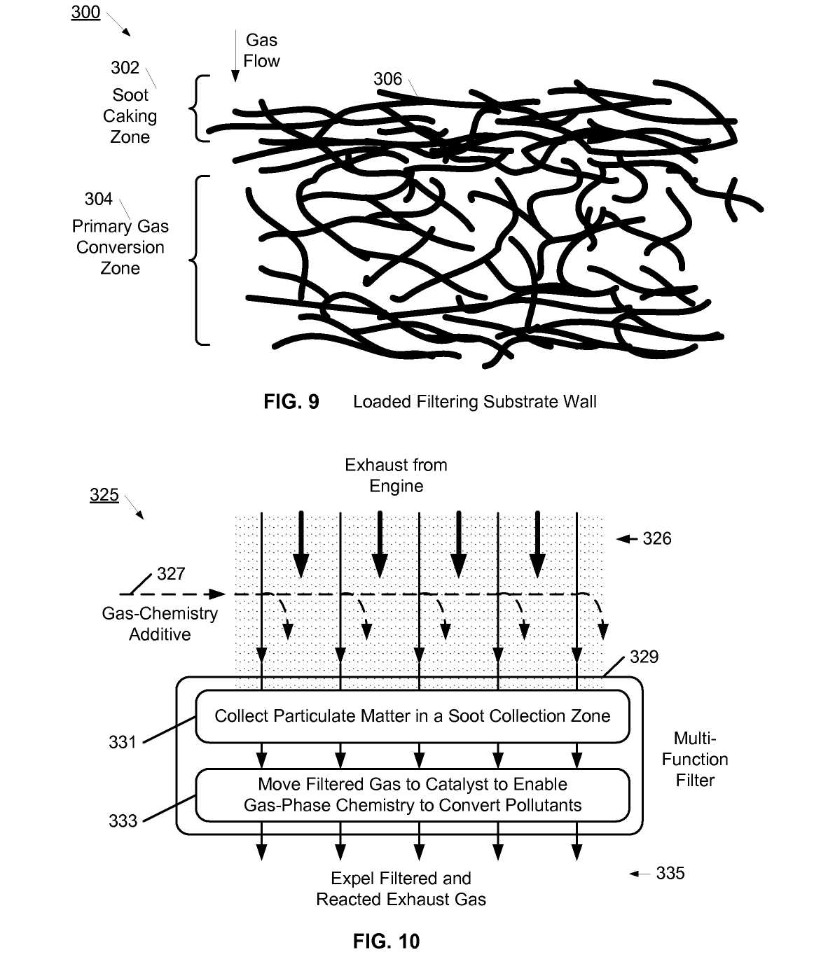

Referring now to FIG. 9, another cell wall 300 is illustrated. Cell wall 300 shows a cell wall loaded with washcoat and catalyst. Accordingly, fibers 306 are heavily loaded with washcoat and one or more types of catalyst. Even though the fibers, fiber bundles, and fiber clumps are heavily loaded with washcoat and catalyst, an effective soot capture zone 302 is present, and the gas-phase zone 304 allows for relatively unrestricted flow. In this way, even when fully loaded with catalyst and washcoat, a highly efficient multifunction filter is provided, with both excellent back pressure characteristics and effective emission control. It will be appreciated that washcoat and catalyst loading will be determined according to application specific requirements, including the level of conversion required within the filter, the size of the filter, the expected flows, and the expected life. Generally, the need for heavier catalyst loading will increase as more demanding emission requirements come into effect. The multi-function filter may be loaded with washcoat and catalyst at a loading rate of 10 grams per cubic foot, 20 grams per cubic foot, and 30 grams per cubic foot or more. In another case loading volumes as high as 20 g/l to 150 g/l may also be used. In some instances, washcoat and catalyst loadings of 10 to 400 grams per cubic foot may be necessary. It will be appreciated that heavier catalyst loadings may be desirable to support multiple catalysts, to support conversions that consume or degrade catalyst, or to allow for more efficient conversions for slower reactions. By enabling a heavier loading of catalyst, the multifunction filter allows a single substrate to perform functions previously implemented only in multiple substrates in multiple devices. Importantly, even with these heavy load requirements, the resulting multifunction filter may operate with an impact on back pressure that is 0% to 50% increase over the back pressure of the filter without the washcoat and catalyst. This means, that even when fully loaded with washcoat and catalyst, the multi-function filter does not cause an undue backpressure to the engine. In this way, the overall engine system is able to maintain fuel efficiency and meet performance goals, even when the multifunction filter is heavily loaded.

Referring now to FIG. 10, a general process for using a multifunction filter is illustrated. In process 325 exhaust gas is received from an internal combustion engine as shown at block 326. In some cases, a gas-chemistry additive may be added as shown at 327. This additive is mixed with exhaust gas to form a material that is more easily reacted, filtered, or catalyzed within the multifunction filter 329. The gas is received into the multifunction filter 329 where a soot collection zone 331 first captures soot or other particles or particulate matter. The filtered gas is then passed into a gas-phase zone as shown at block 333. In gas-phase zone 333, pollutant gas molecules contact catalyst, and react to form less harmful materials. The filtered and reacted gas is then exhausted as shown at 335. It will be appreciated that gas reactions may start as soon as there is contact between the gas phase species and the solid phase catalyst. Depending on the flow rates, flow patterns, and turbulence, the reaction can be pore diffusion limited, mass transfer limited, or chemical concentration limited.

FIG. 11 shows a multifunction filter 400 having a single bonded fibrous substrate 402. The fibrous substrate 402 is heavily loaded with washcoat and catalyst as shown at block 404. Although the particular level of loading is application-specific, loads of 10 to 400 grams per cubic foot or more may be advantageously used. The multifunction filter 452 also has a set of soot collection zones 406, typically positioned on the surface walls for inlet channels of the filter. The multifunction filter 402 also has a set of gas reaction zones 408. These gas reaction zones are typically inside the channel walls of the multifunction filter. Prior to washcoat and catalyst loading, the fibrous substrate 402 typically has a porosity of about 55% to about 70%. It will be appreciated other porosities may be selected according to application needs, for example from 50% porosity to 80% porosity. Importantly, loading or unloading soot from the soot collection zone has an insignificant channeling effect.

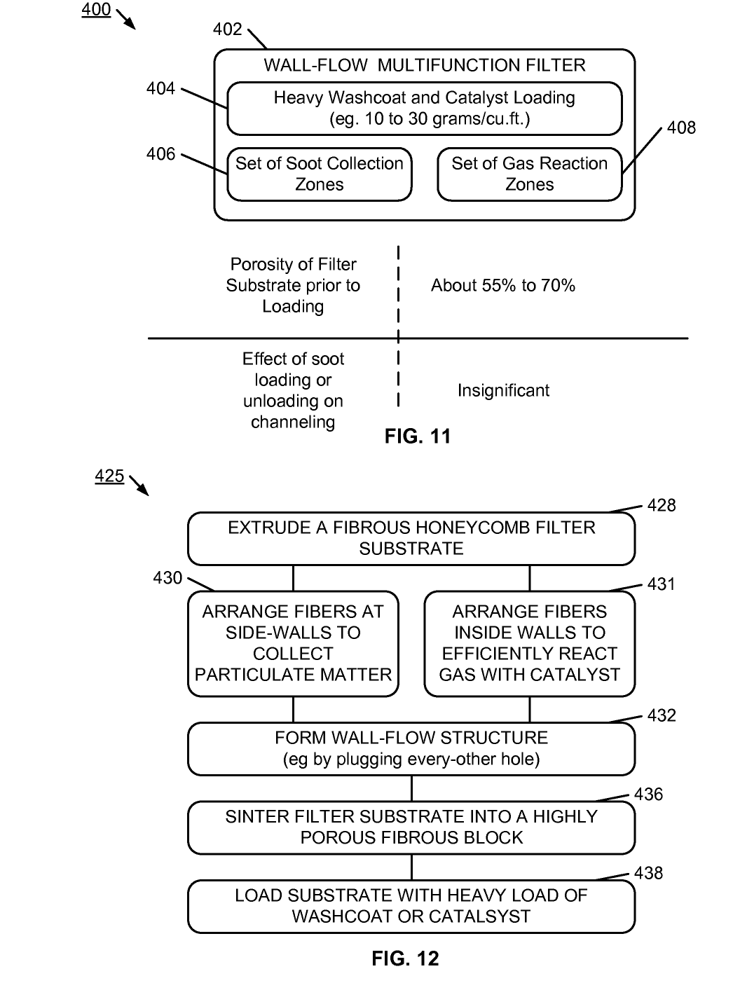

Referring now to FIG. 12, a process of making a multifunction filter is illustrated. Process 425 uses an extrusion process to extrude a honeycomb filter substrate as shown in block 428. This honeycomb substrate has a fiber arrangement on the surface walls particularly constructed to have a highly uniform pore structure for collecting target particular matter as shown at block 430. In this way, specific fiber diameters, sizes of pore formers, and amounts of organic material are selected to construct a pore structure for the target particular matter. Fibers are also arranged inside the walls to form a uniform open, inter-connected pore network for facilitating gas contact with the catalyst as shown at block 431. The fibrous substrate is made into a wallflow structure by plugging every other hole at each end as shown in block 432. The green substrate is dried and sintered into a bonded fibrous block as shown in 436. The substrate is then loaded with a heavy load of washcoat and catalyst as shown in block 438. In one example, the loading of washcoat and catalyst may exceed even 30 grams per cubic foot.

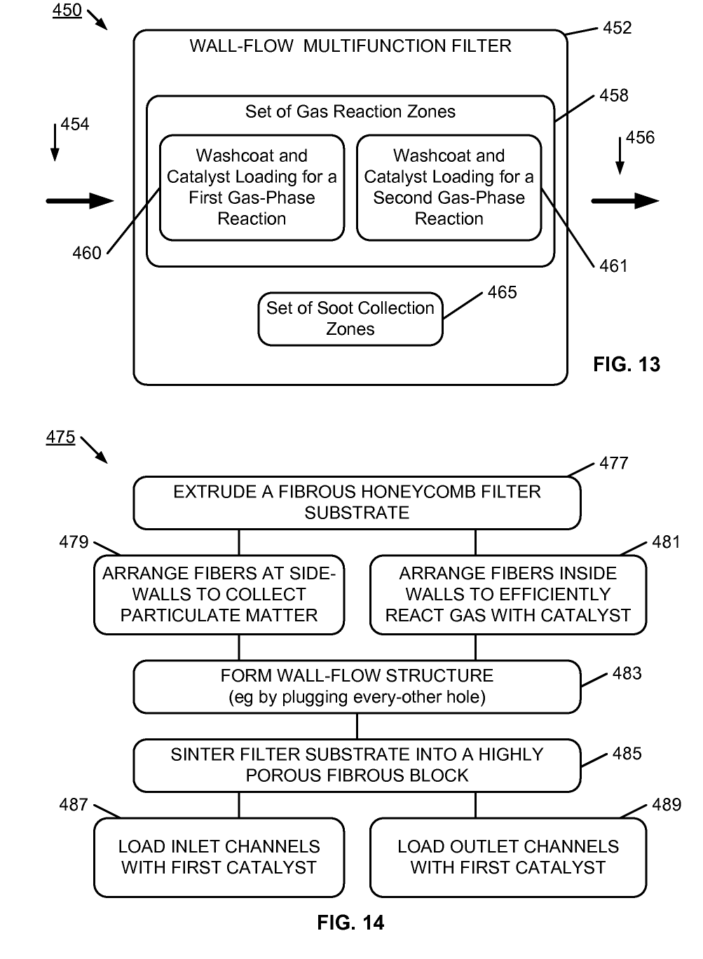

Referring now to FIG. 13, another wallflow multifunction filter 450 is illustrated. Multifunction filter 450 has a bonded fibrous substrate 452 as previously discussed. The multifunction filter 452 has a set of soot collection zones 465 arranged to capture soot in a highly uniform arrangement of pores. The multifunction filter 452 also has a set of gas-phase reaction zones. Here, the filter has multiple zones, with each zone having a catalyst for reacting a different pollutant gas. For example, zone 460 has a washcoat and catalyst for reacting a first pollutant gas, while zone 461 has a different catalyst for reacting another pollutant gas. Accordingly, an inlet gas 454 is filtered through one or more soot collection zones 465 and then received into the gas-phase reaction zones. Each zone reacts a different pollutant gas, thereby exhausting a filtered and dual reacted gas 456.

FIG. 14 shows a process 475 for manufacturing the multifunction filter 450 illustrated in FIG. 13. Process 475 extrudes the fibrous honeycomb filter substrate as shown in block 477. The extrusion process arranges fibers in the soot collection zone 479, as well as fibers in the gas-phase zone 481. Every other hole is plugged to form a wallflow structure 483, and the block is dried and sintered into a bonded fibrous substrate. A washcoat may be applied to the entire substrate, and then a first catalyst is applied through the inlet channels as shown at block 487. A second catalyst may be applied through the outlet channels as shown in block 489. In this way, a soot collection zone is at or near the surface of inlet channel walls, a first gas-phase zone exists inside channel walls, and a second gas-phase zone exists at or near the outlet channel wall. It will be appreciated that other processes may be used for applying washcoat and catalyst to a bonded fibrous substrate.

With reference to FIGS. 1 through 14, a general multifunction filter has been described. This multifunction filter is intended to be adapted to particular and specific emission control requirements. For example, the multifunction filter may have its soot collection zone constructed for capturing one or more specific particle sizes, while the gas-phase zone may be arranged to support the loading of a specific washcoat and catalyst. Accordingly, the multifunction filters described in FIGS. 1 through 14 should not be limited to any particular structure, engine, fuel type, particular matter, or catalyst.

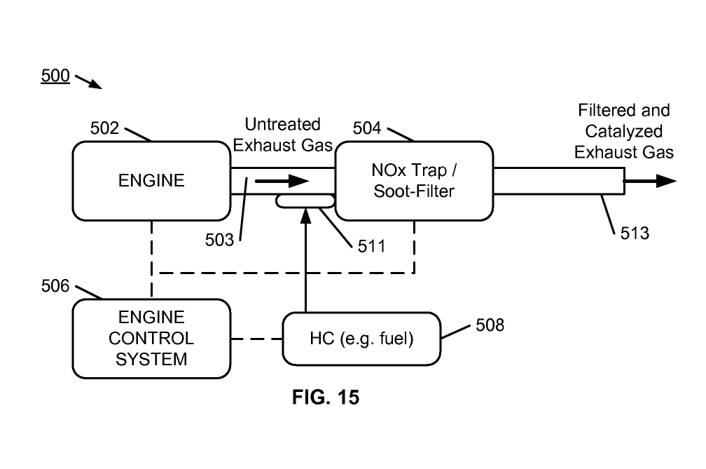

Referring now to FIG. 15, a simplified NOx Trapping filter system 500 is illustrated. It will be understood that the terms NOx trapping, NOx adsorber, and Lean NOx trap (LNT) refer to the same type of device, and may be used interchangeably. This is an example of the integration of the LNT and LNT-SCR functionality onto a ceramic particulate filter. Filter system 500 is similar to the general multi-function filters and systems described with reference to FIGS. 1 to 14, and therefore will not be described in detail. The filter system 500 has an internal combustion engine 502, which emits an untreated exhaust gas 503. In one example, engine 502 is a diesel powered engine, although gasoline or other fuel sources may be used. The untreated exhaust gas 503 is mixed with an external supply of hydrocarbon (HC) 508 periodically to regenerate the NOx trap. Such a supply of hydrocarbons may also be used to actively regenerate the filter. The hydrocarbon source may be, for example, a fuel such as a diesel fuel. Using a fuel has the advantage of not having to provide for a different storage system, and fuels generally have a wider range of operating temperatures than additives used in other SCR systems, such as urea.

An engine control system 506 determines a precise amount of HC 508 to meter or inject into the exhaust gas 503 at mixing area 511. In some cases, the HC may be provided as excess fuel. The fuel can be injected directly into the combustion cylinder, or downstream in the exhaust pipe via a secondary fuel injector. The mixing area may be a separate mixing chamber, or may be an atomizing nozzle that assists in injecting and thoroughly mixing the fuel into the exhaust gas 503. In the case where the fuel is injected in the exhaust system, it will be appreciated that an HC injection system must be provided. The HC injection system typically has a pump, injector, and control devices for delivering a precise amount of fuel. The injection system may also have filters and heaters, depending on the type of fuel used. Since the HC injection system adds cost, other arrangements may be used to provide an additional amount of HC. For example, the mixing chamber may be part of the engine piston compression area, where an excess amount of fuel is occasionally injected into the compression chamber. The timing and amount of excess fuel is under the control of the engine control system 506, but typically uses the same injectors as the vehicles regular fuel injection system. In some cases, an excess amount of fuel may be injected late in the engine timing cycle, thereby allowing the excess fuel to mix with exhaust gases and be expelled to the NOx trap-filter 504. Although this approach may have a cost advantage over the separate-HC-injector system, the engine control system needs to carefully control the amount of HC added to avoid excess fuel wetting in the piston, and possible contamination of engine lubricant.

The exhaust gas, which from time-to-time includes excess HC, is received into NOx trap-filter 504. NOx trap-filter 504 performs at least three distinct functions. First NOx trap-filter 504 traps particulate matter in a soot collection zone; second, the NOx trap-filter 504 has a gas-phase zone that traps NOx in a chemically bonded fashion when the engine system is operating in a lean mode; and third, the gas-phase zone reacts the trapped NOx with HC to form less harmful emissions when the engine is operating in a rich mode to periodically regenerate the NOx trapping capability of the gas phase zone. In some cases, NOx trap-filter 504 may perform additional tasks, such as to assist in oxidation and reduction reactions. After passing through NOx trap-filter 504, the filtered and catalyzed exhaust gas 513 is passed to other emission control devices, or may be exhausted to the atmosphere through a muffler, sound abatement, or other device. Also, the NOx trap-filter 504 may enable HC to react with trapped soot in a regeneration process. The HC may react with the soot directly, or may be assisted with a catalyst.

Typically, HC 508 is provided as the same fuel that powers the vehicle engine. However, it will be appreciated that HC may be provided in other gas, liquid or solid forms, or generated on board as a by-product of other processes. Further, it will be understood that the HC 508 may be mixed with other additives prior to injection into the exhaust. In the NOx trap-filter 504, the catalyst may be provided on a zeolite-based, alumina-based, or ceria/alumina washcoat, for example, and be selected from a wide variety of base metals or precious metals. These metals can include platinum, copper, nickel, silver, cobalt, or iron-based formulations, for example. The NOx trap-filter 504 may also have one or more NOx adsorbers, which act to trap NOx when the engine control system 506 causes the engine 502 to operate in a lean mode. The NOx adsorber may be, for example, a metal or metal oxide that forms a stable metal salt in the presence of NOx, such as Ba(NO₃)₂. It will be understood that other adsorber agents may be used.

The NOx trapping mechanism in the gas phase zone of the NOx trap-filter 504 will have generally three components: an oxidation catalyst, for example, platinum (Pt); an adsorbent, for example, barium oxide (BaO); and a reduction catalyst, for example, rhodium (Rh). Generally, the adsorption processes for NO and NO₂ are described as:

NO+½O₂=NO₂

BaO+NO₂+½O₂=Ba(NO₃)₂

These process generally occur during lean engine operation. In diesel engines, most NOx emissions are in the form of nitric oxide (NO), which reacts with oxygen in the presence of the oxidation catalyst to form NO2, as shown in the first equation. The second equation describes the adsorption of NOx in the form of NO2 as an inorganic nitrate.

It will be appreciated that NOx adsorbers may exhibit an undesired reactivity with sulfur compounds that may be present in the exhaust gases of both diesel and gasoline engines. Reactions of sulfur are basically equivalent to the adsorption of NOx, to form barium sulfate (when barium oxide is used to adsorb NOx). For this reason, low sulfur content fuel is desired. Sulfur, acting in this way, essentially poisons the catalyst.

In this example, the NOx trap-filter 504 uses barium oxide as a NOx adsorber and platinum as a catalyst, although many other materials, such as alkaline earths (calcium, strontium, magnesium), alkali metals (potassium, sodium, lithium, cesium) and rare earth metals (lanthanum, yttrium) may be substituted consistent with this disclosure. During operation, the engine control system 506 usually maintains the engine in a lean operating condition to increase fuel economy. During lean operation, the NOx trap-filter 504 is trapping soot in its soot capture zone, and is continuously oxidizing CO to CO₂. If there are excess HCs in the exhaust gas, these HCs may be oxidized, or may react with NOx in some cases. Over time, the NOx trap-filter 504 becomes increasingly saturated with the trapped NOx, and begins to lose its ability to effectively trap NOx. The engine control system 506 may monitor engine performance, and determine when the NOx trap-filter 504 needs to be regenerated. In other cases, a sensor may be used post-filter to detect when an unacceptable level of NOx is passing through the NOx trap-filter 504, which would indicate that regeneration is needed. In simple cases, the NOx trap-filter 504 could be regenerated periodically or responsive to some timing or other event.

Upon a regeneration event (NOx or soot), the engine control system 506 causes additional HC 508 to be injected or placed into the exhaust gas 503. Some of the additional HC may oxidize in the presence of the platinum to generate water, carbon dioxide, and heat. This additional heat is also useful in the regeneration process, as the conversion of the metal salt requires heat, and if sufficient, may also assist in soot regeneration. When heated, the nitrate species become thermodynamically unstable and decompose, producing NO or NO2. For example, the barium metal salt converts back to barium oxide and releases NO₂, with the NO₂. In the presence of the reduction catalyst, such as Rh, the NO and NO2 reacts with the available HC to form water, carbon dioxide, and nitrogen gas. Indeed, with sufficient temperature, the soot (Carbon) may also combine with NOx, thereby removing soot buildup and assisting with NOx reduction. The general equations are for regeneration during rich operation are:

(oxidize some HC) HC+O₂→H₂O+CO₂+heat

(release NO₂ & O₂) 2Ba(NO₃)₂+heat →4NO₂+O₂+2BaO

(react NO₂) HC+NO₂→H₂O+CO₂+N₂

(react soot) C+HC+NO₂→H₂O+CO₂+N₂

It will be understood that “HC” represents one or more hydrocarbons, and the actual balancing of the chemical equations is dependent on the specific HC reacted.

It will be appreciated that as more effective and efficient catalyst and adsorbers materials are found, especially those that have wider operating temperature window, and have durability despite operating at elevated temperatures, they may be advantageously used in NOx trap-filter 504. Due to the highly efficient utilization of catalyst and adsorber within the open pore structure of the NOx trap-filter, the NOx trap-filter exhibits better trapping and conversion efficiencies in a given volume, even while it effectively traps soot within the same filter canister. In this way, as compared to previous lean trap systems, system 500 provides superior filtration, excellent conversion efficiencies, and enables a more compact design and construction.

The filter system 500 enables a single substrate to 1) filter soot from an exhaust gas to meet stringent particulate matter standards, 2) efficiently trap NOx during lean operation; 3) sufficiently reduce NOx during rich operation to meet stringent NOx standards; and 4) maintain engine fuel efficiency by not unduly increasing backpressure due to multiple components and weight of the emission control system. For example, the filter system 500 enables a single substrate, in a single canister, to be installed on a vehicle such that the vehicle meets 2010 EPA, Tier IV off-road applications, and EuroV and Euro VI NOx/soot standards. As will be appreciated, the 2010 EPA and EuroV standards are complex and cover a wide range of vehicles, but a few specific examples will illustrate some to the vehicles that may benefit from the use of the filter system 500. It will be appreciated that other classes of vehicles may benefit, and that system 500 may be used to meet other current or evolving standards using a single substrate. Although only EPA (US) and EuroV (EU) are specifically identified, it will also be understood that other regions and countries have vehicle regulations that may benefit from the single-substrate solution provided by filter system 500. Some specific examples

| STANDARD | | VEHICLE | PM | NOx | |
|---|---|---|---|---|---|
| 1) | EPA 2010-Diesel | Heavy Duty (>8,500 lbs gw) | <.01 bhp-hr | <0.20 | bhp-hr |
| 2) | EPA 2010-Gasoline | Heavy Duty (>8,500 lbs gw) | <.01 bhp-hr | <0.20 | bhp-hr |
| 3) | EuroV | Large Goods Vehicle | — | <2.00 | g/kWh |
| 4) | EuroV-Diesel | Light Duty Commercial | — | <0.28 | g/km |
| | | (>1760 kg & <3500 kg) | | | |
| 5) | EuroV-Gasoline | Light Duty Commercial | — | <0.82 | g/km |
| | | (>1760 kg & <3500 kg) | | | |
| 5) | EuroV-Diesel | Light Duty Commercial | — | <0.234 | g/km |
| | | (>1305 kg & <1760 kg) | | | |
| 6) | EuroV-Gasoline | Light Duty Commercial | — | <0.75 | g/km |
| | | (>1305 kg & <1760 kg) | | | |
| 7) | EuroV-Diesel | Light Duty Commercial | — | <0.18 | g/km |
| | | (<1305 kg) | | | |
| 8) | EuroV-Gasoline | Light Duty Commercial | — | <0.06 | g/km |
| | | (<1305 kg) | | | |
| 9) | EuroV-Diesel | Passenger Car (M1) | — | <0.18 | g/km |
| 10) | EuroV-Gasoline | Passenger Car (M1) | — | <0.06 | g/km |

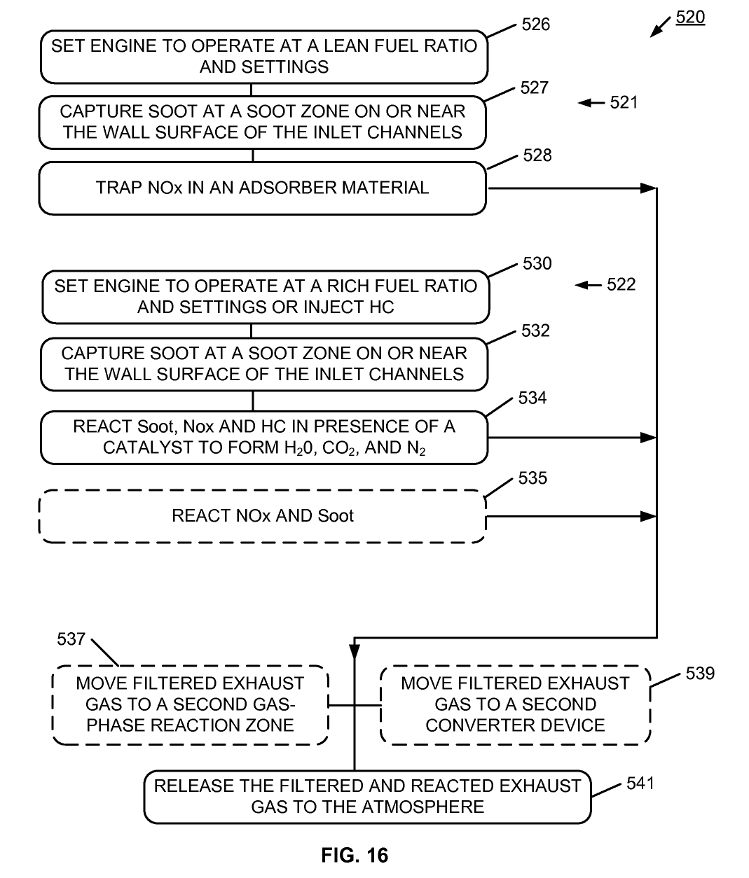

Referring now to FIG. 16, an NOx-filter process 525 is illustrated. Process 525 may operate on a NOx filter system, such as NOx filter system 500 described with reference to FIG. 15. In process 525, an engine control system sets an engine to operate at a relatively lean 521 fuel ratio and settings as shown in block 526. In this way, the engine control system may adjust the amount of NOx initially created, as well as adjust the amount of oxygen available for subsequent devices and processes in the exhaust system. Since the engine is running lean, relatively little excess hydrocarbon is available for NOx conversion, and much of the excess HC is likely oxidized in the filter.

The filter has a soot capture zone on or near the inlet walls of the inlet channels as shown in block 527. Advantageously, the soot capture zone is formed using a highly uniform arrangement of pores. This highly uniform arrangement of pores facilitates an exceptionally even loading of soot particles, which minimizes any undesirable channeling effects. The filtered gas then moves to the gas-conversion zone, where NOx is trapped, and in some cases, additional oxidation or other catalytic functions may be provided.

Since most of the generated NOx is not reacted in this lean environment, the NOx is trapped, for example, by forming metal salts as shown at block 528. Since the filter has a highly desirable open-pore structure, the filter is able to hold sufficient adsorber material for effective NOx trapping. Also, the filter is formed as a wall-flow device, with the walls providing a highly tortuous flow path to the exhaust gas. In this way, a relatively thin wall still provides a sufficient residence time to facilitate NOx trapping. Advantageously, this efficient NOx trapping is accomplished while maintaining excellent backpressure characteristics.

With a significant amount of the NOx trapped, the filtered exhaust gas may then pass through one or more other catalytic zones in the filter as shown in block 537, or may pass through one or more other separate converter devices as shown in block 539. The filtered and reacted gas is then exhausted to the atmosphere as shown in block 541.

The engine control system, for example by algorithm, time, or by measurement, may determine that the filter needs to regenerate its NOx trapping capability. Accordingly, the engine control system places the engine system into a rich 522 state for providing excess hydrocarbons (HC). As previously discussed, the engine control system may directly inject a fuel into the exhaust gas, or may inject excess fuel into the combustion chamber as shown in block 530, and may make other adjustments to fuel, timing, or engine performance. Although a fuel may be injected, it will be understood that other sources of hydrocarbons may be used. The filter has a soot capture zone on or near the inlet walls of the inlet channels as shown in block 532. Advantageously, the soot capture zone is formed using a highly uniform arrangement of pores. This highly uniform arrangement of pores facilitates an exceptionally even loading of soot particles, which minimizes any undesirable channeling effects. After the soot has been trapped at or near the surface of the inlet channel walls, the gas moves inside the channel wall into a gas-phase reaction zone, where the NOx catalyst has been disposed. The NOx catalyst can be any catalyst material that exhibits NOx trapping and/or reduction activity, such as alkaline earths (barium, calcium, strontium, magnesium), alkali metals (potassium, sodium, lithium, cesium) and rare earth metals (lanthanum, yttrium), perovskites, or metal substituted zeolites. To increase the effectiveness of the catalyst, it will be appreciated that one or more washcoats may be disposed prior to depositing the catalyst, such as γ-alumina, titania, or zirconia.

The catalyst facilitates the reaction of HCs and NOx to form into nitrogen gas, carbon dioxide, and water. As the filter heats, due in part to the effects of HCs oxidizing, the metal salts react to release NOx, primary as NO₂, as shown at block 533. The NOx reacts with the excess HCs to form nitrogen gas, carbon dioxide, and water as shown in block 534. In some cases, sufficient heat or proper lower temperature catalysts may be provided so that at least some of the soot also reacts with the NOx, thereby advantageously acting to simultaneously oxidize soot and other emissions through the formation of oxygen species formed during the chemical reaction for NOx adsorption, as shown in block 535. From time to time, excess HC may also be reacted with soot to remove accumulated soot deposits. This regeneration reaction may be facilitated by one or more catalysts.

In some cases, the filter may have another gas-phase zone as shown one in block 537, for example, on the wall surface of the output channel. In this arrangement, the exhaust gas passes through the soot capture zone on the inlet channel wall, moves through the gas-phase zone inside the channel wall, and passes through this second gas-phase zone as the gas exits the channel wall into the output channel. In this way, another catalytic reaction they be supported, such as an oxidation reduction. In another example, a separate catalyzing or filtering device may be arranged downstream in emission system as shown in block 539.

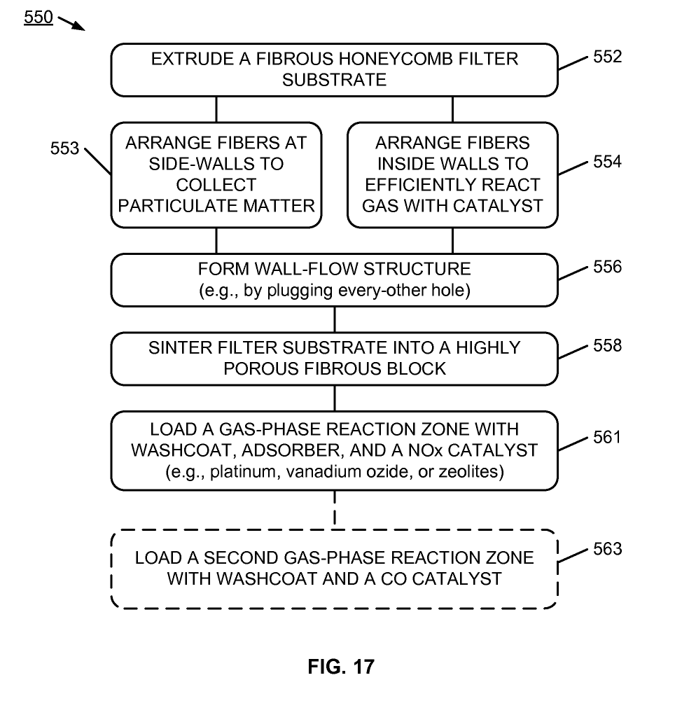

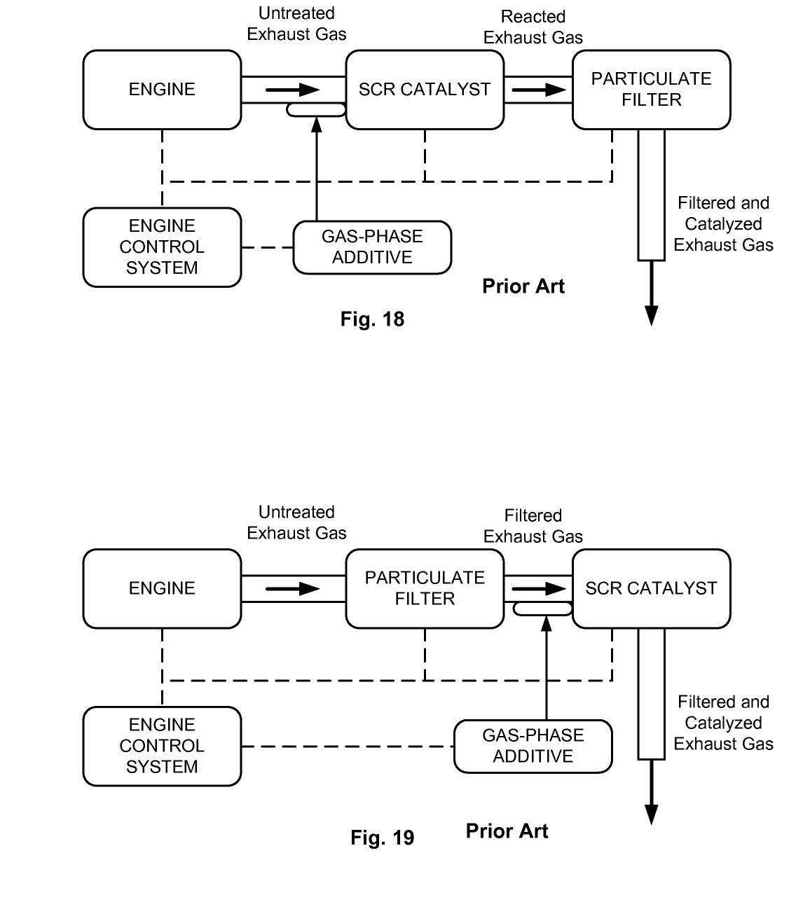

Referring now to FIG. 17, a process for making an NOx trapping-filter is illustrated. Process 550 extrudes a fibrous honeycomb filter substrate as shown in block 552. As previously described, these fibers may be glass, ceramic, metal, oxide, silicon carbide, or other fiber material. The fiber it may be provided as fiber strands, or may be provided as precursors that form a fiber-like structure during a sintering process. The fiber itself may also change morphology and composition during the sintering process. The extrudable mixture also has pore formers, plasticizers, fluids, and other materials mixed to a rheology for proper extruding as previously described. In some constructions, the washcoat material or precursors may be included in the extrudable mixture, and the washcoat exposed or formed during the sintering process. In this way, the additional step of applying the washcoat may be avoided or simplified, and the washcoat is evenly distributed throughout the filter substrate. The honeycomb substrate has a fiber arrangement on the surface walls particularly constructed to have a highly uniform pore structure for collecting soot as shown at block 553. Rearranging of pores may be selected according to the type of internal combustion engine and the expected soot loading. For example, pore size and arrangement may be adjusted according to whether the internal combustion engine is a gasoline engine or diesel engine. In this way, specific fiber diameters, sizes of pore formers, and amounts of organic material are selected to construct a pore structure for the target soot. Fibers are also arranged inside the walls to form a uniform open cell network for facilitating HC contact with the catalyst as shown at block 554. It will be understood that fiber structure also enables the HC to contact and react with trapped soot, either directly or with a catalyst. In this way, excess HC is also used to regenerate or burn-off the soot.

The fibrous substrate is made into a wallflow structure by plugging every other hole at each end as shown in block 556. The green substrate is dried and sintered into a bonded fibrous block as shown in 558. It will be understood that in some cases the plugging process of block 556 may be performed after the sintering process of a 558, depending on manufacturing process. In sintering process of 558, the bonded fibrous structure may be formed in different ways. For example the bonded fibrous structure may be constructed as an arrangement of individual fiber or fiber-like structures that are bonded together at overlapping nodes. In another example, fiber structures include individual fibers, fibers formed into multi-fiber bundles or multi-fiber clumps. These collections of fiber structures bond with other fibers, bundles, or clumps to form a bonded fibrous structure having a highly desirable open pore network. It will also be appreciated that the bonded fibrous structure may use fiber strands in the extrudable mixture, which are then bonded to other fibers during sintering, or the extrudable mixture may have precursors to the fiber or fiber-like structure, whereby the fibers or fiber-like structures form during the sintering process. It is possible for the fibers to be aligned omni-directionally, or aligned in a particular direction during the extrusion process. It will also be understood that the fibers or fiber-like structures may be formed from different materials. For example, ceramics, silicon carbide, or metals may be used as the fiber or fiber precursors. It will also be understood that the bond between fibers, fiber bundles, or the fiber-like structures may be ceramic, glass, liquid state sintered, solid state sintered, chemical, or another type of bond. For the SCR-filter, it is the unique functional characteristics of the resulting bonded structure that is most meaningful, since there are many ways to commercially manufacture such a fibrous bonded structure.

The substrate is then loaded with a heavy load of washcoat, adsorber material and catalyst as shown in block 561. Several techniques used for coating ceramic honeycomb substrates in laboratory or commercial environments are known in the field. Additional steps may be taken to specifically place the washcoat and catalyst in certain areas, example in a zoned or layered coating, to place the catalysts where desired. Additionally the particle size of the washcoat/catalyst, or the suspension slurry concentrations may be adjusted depending on the coating levels and penetration into wall required. The catalyst may be selected for its NOx conversion efficiency, operating temperature/chemical ranges, and lifecycle characteristics. It is appreciated that due to better dispersion, less amount of catalyst, especially expensive components such as platinum and rhodium, may be needed to reach a certain level of reaction efficiency and reaction rate. It will be understood that more than one type of catalyst may be used, and different types of catalyst may work better in different specific applications. For example, alkali metals, such as potassium, exhibit superior NOx adsorption performance at high temperatures relative to alkaline earths, such as barium.

It will be appreciated that washcoat and catalyst loading will be determined according to application specific requirements, including the level of conversion required within the filter, the size of the filter, the expected flows, and the expected life. Generally, the need for heavier catalyst loading will increase as more demanding emission requirements come into effect. The lean NOx filter may be loaded with washcoat, adsorber, and catalyst at a loading rate of 10 grams per cubic foot, 20 grams per cubic foot, and 30 grams per cubic foot or more. In some instances, washcoat, adsorber and catalyst loadings of 10 to 400 grams per cubic foot may be necessary or desirable. It will be appreciated that heavier catalyst and adsorber loadings may be desirable to support multiple catalysts, to support conversions that consume or degrade catalyst, or to allow for more efficient trapping or conversions for slower reactions. By enabling a heavier loading of catalyst, the filter allows a single substrate to perform functions previously implemented only in multiple substrates in multiple devices. Importantly, even with these heavy load requirements, the resulting lean trapping filter may operate with an impact on back pressure that is 0% to 50% increase over the back pressure of the filter without the washcoat, adsorber and catalyst. This means, that even when fully loaded with washcoat, adsorber and catalyst, the lean NOx filter does not cause an undue backpressure to the engine. In this way, the overall engine system is able to maintain fuel efficiency and meet performance goals, even when the trapping filter is heavily loaded.

In an optional construction, a second gas-phase reaction zone may be created by depositing a second catalyst in a different area of the NOx trapping-filter as shown in block 563. For example, this second gas-phase zone may be an oxidation zone downstream from the soot capture zone and the first gas-phased zone where NOx is trapped and later reacted. In this arrangement, the second gas-phase zone may perform an oxidation process, such as the conversion of carbon monoxide to carbon dioxide. The second conversion zone may be positioned separately and distinctly from the NOx adsorption/conversion zone, or some overlap may be accommodated. In another arrangement, multiple catalysts may be layered in the same area of the fibrous substrate. In this case, multiple catalysts are disposed on the same substrate, which facilitate multiple catalytic conversions, or are arranged such that one conversion supports the next conversion. Accordingly, multiple conversion zones may be in separate areas of the substrate, may be arranged as stacked layers in the substrate, or may be layered as multiple catalysts disposed on the same substrate. It will be understood that other zone arrangements and uses may be substituted.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A NOx trapping filter, comprising:
an arrangement of bonded fiber structures forming inlet and outlet channels that are separated by respective channel walls;
a soot capture zone on at least some of the channel walls constructed to enable a highly uniform loading of soot;
a NOx-reaction zone inside at least some of the channel walls;
a NOx adsorber in the NOx-reaction zone for trapping NOx during an HC-lean operating condition.

2. The NOx trapping filter according to claim 1, further comprising a catalyst in the soot capture zone for regenerating the soot.

3. The NOx trapping filter according to claim 1, further comprising a catalyst in the NOx-reaction zone for assisting in the reduction of the adsorbed NOx.

4. The NOx trapping filter according to claim 1, wherein the soot capture zone comprises the bonded fiber structures arranged to form a highly uniform set of pores that are exposed at the surface of the channel walls of the multi-function filter.

5. The NOx trapping filter according to claim 1, wherein the NOx-reaction zone comprises the bonded fiber structures arranged to form a highly uniform set of pores inside the channel walls of the multi-function filter.

6. The NOx trapping filter according to claim 1, wherein the bonded fiber structures are one selected from the group consisting of: i) individual fibers bonded at intersecting nodes, ii) fiber bundles cooperating with each other or individual fibers, iii) elongated single crystal fiber-like structures, and iv) elongated polycrystalline fiber-like structures.

7. The NOx trapping filter according to claim 1, wherein the bonded fiber structures have a fiber composition comprising a metal, a ceramic, SiC, Al2O3, or mullite.

8. The NOx trapping filter according to claim 1, wherein the channels are arranged in a honeycomb pattern.

9. The NOx trapping filter according to claim 1, wherein the channels are extruded in a honeycomb pattern.

10. The NOx trapping filter according to claim 1, wherein the soot capture zone consists of side walls of inlet channels.

11. The NOx trapping filter according to claim 1, wherein the soot capture zone comprises a cake filter on the side wall of respective inlet channels.

12. The NOx trapping filter according to claim 1, wherein the soot capture zone extends into the channel wall.

13. The NOx trapping filter according to claim 12, wherein the soot capture zone and the NOx-reaction zone overlap.

14. The NOx trapping filter according to claim 1, wherein the soot capture zone comprises side walls of inlet channels, and the side walls further comprise fibers arranged according to frictional contact with die openings of an extrusion machine.

15. The NOx trapping filter according to claim 1, wherein the NOx-reaction zone comprises an open cell network arranged to generate a tortuous flow path for an exhaust gas.

16. The NOx trapping filter according to claim 1, wherein the NOx-reaction zone comprises a substrate structure of bonded fibers or fiber-like structures.

17. The NOx trapping filter according to claim 1, wherein the NOx-reaction zone comprises more than about 20 grams/cu. ft. of a NOx reduction catalyst.

18. The NOx trapping filter according to claim 1, wherein the NOx-reaction zone comprises rhodium, platinum, zeolites, vanadia, Cu/Fe substituted zeolites, or vanadium as a reduction catalyst or washcoat material.

19. The NOx trapping filter according to claim 1, wherein the NOx adsorber is an alkaline earth, alkali metal, rare earth metal, or metal substituted zeolite.

20. The NOx trapping filter according to claim 1, wherein the NOx adsorber comprises barium oxide.

21. The NOx trapping filter according to claim 1, further comprising a second gas conversion zone having a second catalyst.

22. The NOx trapping filter according to claim 21, wherein the second gas conversion zone is an oxidation zone, and the second catalyst is an oxidation catalyst.

23. The NOx trapping filter according to claim 21, wherein the second conversion zone is inside the channel walls and positioned downstream from the NOx-reaction zone.

24. The NOx trapping filter according to claim 21, wherein the second conversion zone is inside the channel walls and positioned upstream from the NOx-reaction zone.

25. The NOx trapping filter according to claim 21, wherein the second conversion zone catalyst and the NOx reduction catalyst are layered on the fiber structure.

26. The NOx trapping filter according to claim 21, wherein the second conversion zone is adjacent to a gas inlet of the NOx trapping filter and the NOx reaction zone is adjacent to an outlet of the NOx trapping filter.

27. The NOx trapping filter according to claim 21, wherein the NOx reaction zone is adjacent to a gas inlet of the NOx trapping filter and the second conversion zone is adjacent to an outlet of the NOx trapping filter.

28. A NOx control system for an internal combustion engine, comprising:
an inlet for receiving an exhaust gas, the exhaust gas comprising soot and NOx;
an injection system for selectively adding a hydrocarbon (HC) source to the exhaust gas for transitioning from a lean-HC to a rich-HC operating condition;
a fibrous substrate comprised of an organized arrangement of bonded fiber-structures for receiving the NOx, HC, and soot;
a soot filtering zone on the fibrous substrate for collecting the soot;
a NOx-conversion zone in the fibrous substrate that is loaded with a NOx adsorber to trap NOx during lean operation and release NOx during rich-operation; and
an engine control system for selectively injecting the hydrocarbon source.

29. The NOx control system according to claim 28, wherein the NOx conversion zone is further loaded with a reduction catalyst for reacting the released NOx and the HC to form carbon dioxide, nitrogen, and water.

30. The NOx control system according to claim 28, further including an oxidation phase zone in the fibrous substrate that is loaded with an oxidation catalyst selected to convert CO to CO₂.

31. The NOx control system according to claim 28, wherein the injection system is arranged to inject fuel into an exhaust line that is outside the engine. or is arranged to inject excess fuel into the engine's piston chamber.

32. The NOx control system according to claim 28, wherein the injection system is arranged to inject excess fuel into the engine's piston chamber.

33. The NOx control system according to claim 28, wherein the hydrocarbon source is the same type of fuel used by engine.

34. The NOx control system according to claim 28, wherein the hydrocarbon source is different from the fuel used by engine.

35. The NOx control system according to claim 28, wherein the fibrous substrate is constructed from i) individual fibers bonded at intersecting nodes, ii) fiber bundles cooperating with each other or individual fibers, iii) elongated single crystal fiber-like structures, or iv) elongated polycrystalline fiber-like structures.

36. A method for soot and NOx emission control, comprising the steps of:
receiving an exhaust gas at an inlet channel wall of a NOx trapping filter substrate, the exhaust gas comprising NOx and soot, and from time-to-time, an excess supply of hydrocarbon (HC).
capturing the soot at the inlet channel wall of the substrate in uniformly arranged pores;
receiving the NOx into a gas-phase zone inside the channel walls of the substrate where a NOx adsorber traps NOx during periods when excess HC is not present in the exhaust gas;
releasing NOx from the NOx adsorber during periods when excess HC is present in the exhaust gas;
reacting the released NOx and HC in the gas-phase zone to form nitrogen gas, carbon dioxide, and water; and
exhausting the nitrogen gas, carbon dioxide, and water into an outlet channel of the substrate.

37. The method according to claim 36, wherein the reacting step further includes reacting the released NOx and HC in the gas-phase zone using a reduction catalyst to form nitrogen gas, carbon dioxide, and water.

38. The method according to claim 36, wherein:
the exhaust gas further comprises a HC in the form of a fuel.

39. The method according to claim 36, wherein:
the exhaust gas further comprises CO; and
further comprises the step of receiving the CO into a gas-phase zone that is positioned in the channel walls of the substrate where an oxidation catalyst facilitates reacting the CO to CO₂.

40. A NOx trapping filter device constructed for installation on a heavy duty vehicle (>8,500 lbs. gw) that 1) receives an unfiltered exhaust gas from an internal combustion engine, 2) receives from time-to-time an excess supply of hydrocarbons in the exhaust gas, and 3) emits a gas having 0.01 g/bhp-hr or less particulate matter and less than 0.20 g/bhp-hr of NOₓ, in compliance with 2010 EPA regulations.

41. The NOx trapping filter device according to claim 40, where the internal combustion engine is a diesel engine.

42. The NOx trapping filter device according to claim 40, where the internal combustion engine is a gasoline engine.

43. A NOx trapping filter device constructed for installation on a Large Goods Vehicle (as defined by the EU) that 1) receives an unfiltered exhaust gas from an internal combustion engine, 2) receives from time-to-time an excess supply of hydrocarbons in the exhaust gas, and 3) emits a gas having less than 2.00 g/kWh of NOₓ, in compliance with EuroV regulations.

44. A NOx trapping filter device constructed for installation on a light duty commercial vehicle (>1760 kg & <3500 kg) that 1) receives an unfiltered exhaust gas from a diesel internal combustion engine, 2) receives from time-to-time an excess supply of hydrocarbons in the exhaust gas, and 3) emits a gas having less than 0.28 g/km of NOₓ, in compliance with EuroV regulations.

45. A NOx trapping filter device constructed for installation on a light duty commercial vehicle (>1760 kg & <3500 kg) that 1) receives an unfiltered exhaust gas from a gasoline internal combustion engine, 2) receives from time-to-time an excess supply of hydrocarbons in the exhaust gas, and 3) emits a gas having less than 0.082 g/km of NOₓ, in compliance with EuroV regulations.

46. A NOx trapping filter device constructed for installation on a light duty commercial vehicle (>1305 kg & <1760 kg) that 1) receives an unfiltered exhaust gas from a diesel internal combustion engine, 2) receives from time-to-time an excess supply of hydrocarbons in the exhaust gas, and 3) emits a gas having less than 0.235 g/km of NOₓ, in compliance with EuroV regulations.

47. A NOx trapping filter device constructed for installation on a light duty commercial vehicle (>1305 kg & <1760 kg) that 1) receives an unfiltered exhaust gas from a gasoline internal combustion engine, 2) receives from time-to-time an excess supply of hydrocarbons in the exhaust gas, and 3) emits a gas having less than 0.075 g/km of NOₓ, in compliance with EuroV regulations.

48. A NOx trapping filter device constructed for installation on a light duty commercial vehicle (<1305 kg) or a passenger car (M1) that 1) receives an unfiltered exhaust gas from a diesel internal combustion engine, 2) receives from time-to-time an excess supply of hydrocarbons in the exhaust gas, and 3) emits a gas having less than 0.18 g/km of NOₓ, in compliance with EuroV regulations.

49. A NOx trapping filter device constructed for installation on a light duty commercial vehicle (<1305 kg) or a passenger car (M1) that 1) receives an unfiltered exhaust gas from a gasoline internal combustion engine, 2) receives from time-to-time an excess supply of hydrocarbons in the exhaust gas, and 3) emits a gas having less than 0.06 g/km of NOₓ, in compliance with EuroV regulations.
